(19) United States
(12) Patent Application Publication
(10) Pub. No.: US 2025/0326588 A1
(43) Pub. Date: Oct. 23, 2025

(54) DEVICE FOR SINGULATING BULK MATERIAL AND SORTING SYSTEM FOR THE SINGULATED FEEDING OF ORIENTED BULK MATERIAL PARTS

(71) Applicant: SwissP Defence AG, Thun (CH)

(72) Inventors: Peter Biedermann, Lyss (CH); Peter Spatz, Bern (CH)

(73) Assignee: SwissP Defence AG, Thun (CH)

(21) Appl. No.: 19/101,117

(22) PCT Filed: Aug. 4, 2023
(86) PCT No.: PCT/EP2023/071726

§ 371 Date: Feb. 4, 2025

(30) Foreign Application Priority Data
Aug. 4, 2022 (DE) 102022119673.9

(51) Int. Cl. B65G 47/14; B65G 47/24; F42B 33/02

(52) U.S. Cl. CPC B65G 47/1471; B65G 47/24; F42B 33/0207; B65G 2201/04

(57) ABSTRACT

The invention relates to a device for singulating bulk material, such as ammunition parts, for example cases and/or projectiles, comprising an endless conveyor which is arranged with respect to a bulk material source in such a way that, under the influence of its weight, bulk material falls into conveyor trays, in particular being arranged in a row, of the endless conveyor which are conveyed past the bulk material source, wherein the conveyor trays have a receiving space for the bulk material which decreases in size during the conveying.

The invention relates to a device for singulating bulk material, such as ammunition parts, for example cases and/or projectiles. The invention further relates to a sorting system for the singulated feeding of oriented bulk material parts, preferably bulk material parts with at most one axis symmetry. The invention further relates to the use of corresponding devices and sorting systems. Finally, the invention relates to a system for producing ammunition which has a case, an ignition element and a projectile.

Devices for singulating bulk material, which are also referred to below as a singulating device, are known, for example, from DE 10 2013 208 422 A1. it comprises an endless conveyor in the form of a transport tray chain which is conveyed past a bulk material source in such a way that bulk material falls into the conveyor tray under the influence of its weight force, the conveyor tray is then conveyed via the chain to a transfer station, at which the bulk material, under the influence of its weight force, is transferred via a chute to a discharge conveyor belt, the bulk material parts are then removed from the discharge conveyor belt via a handling robot. Bulk material parts which have not been removed can be returned to the bulk material source via a return chute. An embodiment is also provided in which the handling robot removes bulk material directly from the transport trays.

In order to ensure that no bulk material parts jam between the chain links, namely the transport trays of the transport tray chain, and thus lead to a standstill or to damage to the device, the transport trays are strung together without gaps in such a way that they have a surface which is interrupted only by receiving pockets and also do not form any relevant gaps or cracks when two adjacent transport trays are pivoted along the transport tray chain. This is realized by transport trays which are coupled to one another in an articulated manner and whose side edges which are directed towards one another each have an apron which is curved concentrically about the coupling axes and against which the other side edge bears without gaps irrespective of the bending angle between the two transport trays. Furthermore, freedom from gaps with respect to the guide of the transport link chain is intended to be realized by the transport trays having guide cheeks on both sides, via which cheeks the transport tray chain is supported along the entire length on a guide.

However, the proposed transport trays have a more complex structure, which makes both their design and their production time-consuming and cost-intensive. Furthermore, the guidance of the transport trays on both sides reduces the flexibility with regard to the arrangement of the trays with respect to one another.

Furthermore, there is a need to singulate more bulk material parts in a shorter time (to increase the singulating capacity). For this purpose, the conveying speed of the transport tray chain can be increased with the known device. However, this increases the risk of damaging the bulk material or, owing to the increased speed, of receiving no bulk material at all. Alternatively, a plurality of receiving spaces can be provided in a transport tray by means of the known device, such that a plurality of bulk material parts can be singulated by means of a transport tray. However, the smaller the receiving spaces become, the higher is the risk of said receiving spaces remaining empty as they move past the bulk material source. In this respect, an increase in the singulating capacity is also possible only to a limited extent with this solution.

In addition to the singulating capacity, there is a need, in particular in the case of bulk material which is to be further processed following the singulation, to transfer said bulk material reliably and while maintaining the previously performed singulation to a corresponding further processing station. In this respect, the solution known from the known device with chute and conveyor belt has proved not to be sufficiently reliable. The alternative with a gripper which takes the singulated bulk material directly out of the transport tray is admittedly reliable, but considerably reduces the singulating capacity.

A further challenge exists in the case of bulk material with at most one axis symmetry, which is to be further processed in an automated manner following the singulation. An example of this are cases which, following the singulation, are provided with an ignition element and a projectile in order to provide ammunition. The automation can be performed, for example, in that the case, after the singulation, is transferred to a workpiece carrier which brings the case to different stations at which it is processed.

However, a limiting factor in the case of automated production is in particular the correct orientation of bulk material parts which have at most one axis symmetry. In order, for example, to be able to receive a plurality of cases in a workpiece carrier at the same time in order to increase the production capacity, it is necessary for all the cases to be fastened in the workpiece carrier in the same orientation, for example with the case opening upwards. A solution with which this step can be carried out in an automated manner is not known in the prior art.

It is the object of the invention to overcome the disadvantages of the prior art, in particular to provide a singulating device and a sorting system which overcome the disadvantages of the prior art, in particular have an increased singulating capacity and enable a reliable transfer of the singulated bulk material parts to a further processing station, such as a workpiece carrier, in particular in order to enable an automated further processing of the bulk material parts.

The object is achieved by the independent claims. Preferred embodiments of the invention are specified in the dependent claims. Further advantages, features and properties of the invention are explained by the following description of preferred embodiments of the accompanying drawings:

One aspect of the invention relates to a device for singulating bulk material (singulating device), such as ammunition parts, for example cases and/or projectiles. The device comprises an endless conveyor which is arranged with respect to a bulk material source in such a way that bulk material falls under the influence of its weight force into conveyor trays, in particular being arranged in series, of the endless conveyor which are conveyed past the bulk material source. As described in detail below, the endless conveyor preferably has a drum, around the axis of rotation of which the conveyor trays are arranged in series. Particularly preferably, a plurality of rows of conveyor trays are arranged next to one another along the axis of rotation. As described in detail below, the bulk material source can have a bulk material supply which is open toward the endless conveyor. The endless conveyor can be arranged with respect to the bulk material source in such a way that it, in particular the drum of the endless conveyor, closes the open side of the bulk material supply, in particular in such a way that the bulk material supply and the endless conveyor together delimit a circumferentially closed bulk material supply space. The bulk material supply can preferably have a longitudinal wall, in particular a chute, which lies opposite the endless conveyor, in particular opposite the drum of the endless conveyor. The longitudinal wall is preferably inclined with respect to the horizontal, in particular inclined upwards, preferably inclined upwards by at least 30°, 40°, 60° or 70°. The longitudinal wall and the endless conveyor particularly preferably converge in the direction of gravity, with the result that the bulk material supply space tapers, in particular in a V-shaped or wedge-shaped manner, in particular in the direction of gravity. Furthermore, the bulk material supply preferably has face-side walls which extend between the longitudinal wall and the transfer station and which delimit the bulk material supply space at the face-side. In particular, the face-side walls extend in the direction of the axis of rotation of the drum on the outside with respect to the drum. In particular, a gap is provided between the face-side walls and the drum, the dimensioning of which gap permits a relative movement of the drum with respect to the face-side walls, but prevents bulk material from slipping into the gap. In particular, the gap between the drum and the face-side walls extends, in particular in the axial direction, for this purpose between 1 mm and 10 mm, preferably between 2 mm and 8 mm, particularly preferably between 3 mm and 5 mm. The receiving space is preferably closed in the gravitational direction, apart from a gap which can have the same dimensions as the gap described above, by the endless conveyor and the bulk material supply. The bulk material supply space can be open in the upward vertical direction.

In the preferred embodiment, in which the endless conveyor is a drum, the latter is preferably rotationally driven about the axis of rotation of the drum in such a way that the drum shell constitutes a movable delimiting wall with respect to the bulk material supply space. The drum is preferably rotationally driven in such a way that the drum shell has a movement component which is directed upward in the vertical direction. As a result, bulk material parts lying in the bulk material supply can pass into the conveyor tray in a region which is lower in the gravitational direction and can then be raised by the rotation of the drum in order to be fed to the transfer station described in detail below. As described in detail below, the conveyor trays can be formed by cutouts in the drum which, proceeding from the drum coat, extend inward in the radial direction. In particular, as a result, bulk material can fall in the lower region of the bulk material supply under the influence of its weight force into the conveyor trays which are conveyed past the bulk material source. The rotational axis of the drum is preferably spaced apart upward and/or downward in the vertical direction from the base of the bulk material supply, which is preferably defined by the lowermost position in the gravitational direction, at which bulk material passing into the bulk material supply from above can pass, by a maximum of 50%, 40%, 30%, 20%, 10%, 5%, 3% or 1% of the radial extension of the drum. Particularly preferably, the axis of rotation of the drum lies substantially at the same height of the base of the bulk material supply in the vertical direction. As a result, it can be ensured, in particular, that the cutouts which are formed in the drum, on entry into the bulk material supply space, form a hole which lies below the base in the gravitational direction and into which the bulk material parts can fall under the influence of their weight force. As a result, a particularly reliable reception of bulk material parts in the conveyor trays is ensured. Bulk material in the sense of the present invention is to be understood to mean, in particular, a multiplicity of bulk material parts. A bulk material part is to be understood to mean, in particular, a single bulk material part, in particular singulated from bulk material.

The singulation apparatuses and/or sorting systems according to the invention are preferably designed to singulate or orientate axially symmetrical, in particular rotationally symmetrical, bulk material parts. They are particularly preferably designed to singulate or orientate rotationally symmetrical bulk material parts with a defined front side and rear side along the axis of symmetry and/or the extension of which parallel to the axis of symmetry is at least twice as large as the extension of which orthogonally to the axis of symmetry. It has been found that such bulk material parts can be singulated or oriented particularly reliably with the devices according to the invention. In particular by the greater extension along the axis of symmetry, the orientation into the initial orientation and target orientation described below is simplified, in particular by utilizing the weight force. In particular, the singulating devices and/or the sorting systems are designed for singulating or orienting ammunition parts, in particular cases and/or projectiles. For the abovementioned purposes, the receiving space of the conveying trays can be adapted to the dimensioning of the corresponding bulk material parts. In particular, the receiving space of the conveyor trays, in particular independently of their state, such as receiving state and singulating state, can have a longitudinal extension along a predefined initial orientation direction of 100% to 195%, preferably 105% to 150%, particularly preferably 110% to 130%, of the extension of the bulk material parts to be singulated along their axis of symmetry, in particular axis of rotational symmetry. The starting orientation direction is to be understood to mean, in particular, the direction in which the bulk material part to be singulated is intended to be orientated in addition to the singulating. In the case of axially symmetrical bulk material parts, the initial orientation relates in particular to the orientation of the axis of symmetry, in particular the axis of rotational symmetry, of the bulk material parts. Preferably, the axis of symmetry of the bulk material part in the initial orientation is oriented parallel to the axis of rotation of the drum. It can thereby be ensured that a bulk material part can be received in a conveyor tray in the initial orientation direction in the initial orientation, wherein at the same time a second bulk material part is prevented from adjoining the first bulk material part in the initial orientation direction. As a result, in the case of the decrease in size, described below, of the receiving space into the separating state, a reduction in the initial orientation direction can be dispensed with, as a result of which the risk of incorrect orientation is reduced.

According to one aspect of the invention, the conveyor trays have a receiving space for the bulk material which decreases in size during the conveying. As a result, a relatively large receiving space can be provided in order to ensure that at least one bulk material part passes into the receiving space, wherein a subsequent decrease in size of the receiving space ensures that bulk material parts which are possibly received beyond the one bulk material part are forced out of the conveyor tray through the receiving space which decreases in size. The conveyor trays are preferably conveyed from the bulk material source, in particular the base of the bulk material supply, in the conveying direction to a further processing station, in particular an orientation station and/or a transfer station, in particular as described in detail below. The receiving space preferably decreases in size in the conveying direction between the bulk material source, in particular the bulk material supply, in particular the base of the bulk material supply, and the further processing station. The decrease in size from a bulk material receiving state, in which the receiving space is the largest, to a separating state, in which the receiving space is the smallest, preferably takes place completely during a rotation of the drum of the endless conveyor by 10° to 180°, preferably by 20° to 150°, particularly preferably by 30° to 120°, most preferably by 50° to 100°. In particular, the decrease in size takes place during a movement of the conveyor tray from a three o'clock or nine o'clock position into a twelve o'clock position.

The receiving space preferably decreases in size during the conveying from a bulk material receiving state, in which a multiplicity of, in particular identical, bulk material parts fit into the receiving space, into a separating state, in which only a separated bulk material fits into the receiving space. In this case, the receiving space preferably has a constant longitudinal extension along the initial orientation direction described above, in particular along the axis of rotation of the drum. The receiving space preferably decreases in size in a decrease direction which runs transversely, in particular orthogonally, with respect to the initial orientation direction, in particular the axis of rotation of the drum. The receiving space preferably decreases in size in the decrease direction in such a way that the extension of the receiving space in the decrease direction in the singulating state is smaller than the extension of the bulk material along its axis of symmetry. It can thereby be ensured that the separated bulk material is displaced in the predefined initial orientation direction or falls out of the receiving space in the singulating state, with the result that the receiving space is completely empty. In order to avoid the latter, the predetermined initial orientation preferably corresponds to an orientation of the axis of symmetry substantially parallel to the horizontal. Substantially is to be understood to mean, in particular, a deviation of at most ±30°, 25°, 20°, 15°, 10°, 5°, 3° or 1° from the horizontal. This horizontal initial orientation ensures, in particular, that bulk material parts, the longitudinal extension of which is at least twice as large as the radial extension thereof, are driven into the predefined initial orientation by the gravitational force. The above-described constant longitudinal extension of the receiving space additionally ensures in this case that bulk material parts already located in the initial orientation are not forced out of the latter.

The receiving space, in particular in the singulating state, is preferably adapted to the shape of the bulk material in such a way that the bulk material is forced into a predefined initial orientation. In addition to the measures described above, such as dimensioning, constant longitudinal extension, decrease direction and horizontal initial orientation, this can additionally be ensured by the receiving space in the singulating state being approximated to the shape of the bulk material. This is to be understood to mean, for example in the case of cylindrical bulk material parts, such as cases, that the receiving space has a cylindrical section shape in the singulating state, in particular the receiving space can have a semicylindrical shape in the singulating state. In particular, the radius of the semicylindrical receiving space can be between 100% and 195%, preferably between 105% and 150%, particularly preferably between 110% and 130%, of the radius of the cylindrical bulk material to be singulated.

The receiving space preferably decreases in size in such a way that bulk material located beyond a separated bulk material in the receiving space falls out of the receiving space, in particular is pushed out of the latter. As described above, this can be realized, in particular, by a decrease in size of the receiving space in the outward radial direction, relative to the initial orientation or to the axis of rotation of the drum. This can particularly preferably be realized by the movable tray wall described in detail below, which, upon the decrease in size of the receiving space from the receiving state into the separating state, pushes the excess bulk material parts out of the receiving space, in particular pushes them outward in the radial direction in the direction of the drum coat.

The receiving state is, in particular, the state in which the receiving space of the conveyor trays, in particular in the region of the bulk material source, is the largest. In the receiving state, preferably at least 2, 3, 5, 8, 10 or 12 bulk material parts fit into the receiving space, wherein preferably only one bulk material part finds space along the longitudinal extension of the receiving space. Accordingly, it is preferred that the multiplicity of bulk material parts which can be received in the receiving state can be received one above the other in the predefined initial orientation, in other words orthogonally to the initial orientation direction. In the singulating state, the receiving space can be smaller than the dimension of the bulk material part to be singulated, as long as the receiving space is still so large that a separated bulk material part oriented in the initial orientation does not fall back into the bulk material source. For this purpose, the receiving space in the singulating state can be of semicylindrical design, for example in the case of cylindrical bulk material parts.

Preferably, the conveyor trays each have a movable tray wall for decreasing the size of the respective receiving space. In particular, the conveyor trays each have a tray base, in particular of concave shape, with respect to which the respective tray wall is movable. Preferably, the tray wall is pivotable, in particular pivotably mounted in the conveyor tray. In order to decrease the size of the receiving space from the bulk material receiving state into the separating state, the tray wall is preferably movable, in particular pivotable, from a bulk material receiving position into a separating position. Preferably, the tray wall has a recess for receiving the separated bulk material part in the separating state. Preferably, the recess is of cylindrical-section-shaped design. Particularly preferably, the tray wall extends substantially along a planar surface with respect to which the recess is recessed in the radial direction with respect to the axis of rotation of the drum.

The receiving space in the bulk material receiving state is preferably of substantially disk-section-shaped design. In the receiving state, the disk section preferably extends between 10° and 90°, particularly preferably between 20° and 70°, in particular between 30° and 60°. The disk-section-shaped receiving space is preferably delimited on one side by the tray wall in the circumferential direction, in particular with respect to the pivot axis of the tray wall and/or with respect to the central axis of the disk section, and is open toward the bulk material source on the side which lies opposite in the circumferential direction. During the decrease in size of the receiving space, the tray wall preferably moves toward the open side, with the result that the circumferential extension, in particular the angle, of the disk-shaped section decreases in size. In the singulating position, the tray wall particularly preferably assumes the position of the opening side with the result that the disk-section-shaped receiving space completely disappears. In this preferred embodiment, in the singulating state, the receiving space is formed only by the, in particular cylindrical-section-shaped, recess in the tray wall. The tray wall is preferably pivotably mounted on the conveyor tray. In the case of a disk-section-shaped receiving space, the pivot axis is preferably pivotably mounted in the radial direction, with respect to the central axis of the disk section, on the inside, in particular substantially (±20 mm, 15 mm, 10 mm, 5 mm or 3 mm) at the height of the central axis of the disk section, and/or the radially outer coat section is formed by the tray base, in particular a concavely shaped tray base. As described in part below, in the preferred embodiment, in which the endless conveyor has a drum, the receiving space is in particular completely countersunk in the drum coat, in other words formed by a cutout which, starting from the drum coat, extends, in particular exclusively, inward in the radial direction.

A further aspect of the invention likewise relates to a device for singulating bulk material, such as ammunition parts, for example cases and/or projectiles. The device likewise comprises an endless conveyor which is arranged with respect to a bulk material source in such a way that bulk material falls under the influence of its weight force into conveyor trays of the endless conveyor which are conveyed past the bulk material source. The device can be designed as described above, wherein the conveyor trays may or may not have a receiving space for the bulk material which decreases in size during the conveying. For this aspect of the invention, it is only essential that the endless conveyor has a drum, around the axis of rotation of which the conveyor trays are arranged in series. Through the use of a drum according to the invention, a multiplicity of ammunition parts can be singulated in a short time and in a small space. In this case, use is made, in particular, of that coat surface of the drum which is large in relation to the radial extension and is preferably of cylindrical design. In addition, the curved profile of the drum coat has proven to be particularly preferred in order to convey the conveyor trays past the bulk material source in such a way that the bulk material parts fall into the conveyor trays under the influence of their weight force. Furthermore, the use of a drum for the endless conveyor has proved to be particularly advantageous for the formation of the above-described V-shaped or wedge-shaped bulk material supply space. In particular, the curved coat surface, in particular a coat section over between 60° and 120°, for example 90°, can be used as limb of the V-shaped bulk material supply space, with the result that the bulk material parts lying therein fall into the conveyor trays which are conveyed past the bulk material supply along its limb (coat section), utilizing the weight force.

The conveyor trays are preferably formed by cutouts in the drum which, preferably starting from a drum coat, extend in the radial direction, in particular exclusively inward. Conveyor trays designed in this way can also be referred to as countersunk conveyor trays. The countersinking of the conveyor trays prevents, in particular, protruding paddles from damaging bulk material parts in the bulk material source. At the same time, at high drum rotational speeds, bulk material parts are prevented from being thrown out of the device by protruding tray elements. The conveyor trays, in particular the tray wall described above and/or the tray base described above, are preferably countersunk in such a way that, at least in the bulk material receiving state, but preferably also in the separating state, they do not project, or project only insignificantly, in the radial direction, with respect to the axis of rotation of the drum, beyond the drum coat, in particular the theoretical drum coat if no conveyor trays were present. “Only insignificantly” in this regard is to be understood to cover, in particular, sections which project with respect to the coat surface with a radial extension of at most 10 mm, 8 mm, 5 mm, 3 mm or 1 mm and/or convexly shaped sections, for example between the planar surface and the recess of the movable tray wall.

Preferably, the endless conveyor has at least 2, preferably at least 3, 4, 6, 8, 10 or 12, rows of conveyor trays, which are each arranged around the axis of rotation of the drum. Preferably, the individual rows are each arranged next to one another in the direction of the axis of rotation. Preferably, the rows are arranged symmetrically with respect to one another in such a way that conveyor trays arranged next to one another in the direction of the axis of rotation are aligned with one another. As a result, in particular in addition to the rows of conveyor trays in the circumferential direction, rows of conveyor trays along the axis of rotation (axial direction) are also formed. As a result, it is ensured in particular that a plurality of bulk material parts can be singulated at the same time and can also be transferred at the same time to the orientation and transfer station described further below, which enables a rapid loading, in particular charging, of workpiece carriers with a plurality of singulated bulk material parts.

Preferably, the conveyor trays are spaced apart from one another in the circumferential direction (with respect to the axis of rotation of the drum) and/or in the axial direction (direction of the axis of rotation or parallel to the axis of rotation) by less than the greatest extent of the bulk material to be singulated. In particular, the above-described plurality of rows of conveyor trays are spaced apart from one another in the axial direction preferably by at most 50%, particularly preferably by at most 30% or 15%, of the greatest extent of the bulk material to be singulated or of the above-described longitudinal extension of the conveyor trays. As a result, the required installation space for the endless conveyor, in particular for the drum, can be reduced. In particular, the distance between the rows of conveyor trays which are spaced apart in the axial direction can be configured to be so narrow, in particular by relatively narrow webs between the conveyor trays, that bulk material parts which lie between the conveyor trays as they move past the bulk material source can fall, in particular tilt, into the receiving spaces of the conveyor trays via the narrow webs.

Preferably, the receiving space of the respective conveyor trays is adapted to the shape of an axially symmetrical bulk material part in such a way that the axis of symmetry of the bulk material part is driven by its weight force into an orientation parallel to the axis of rotation of the drum. This parallel orientation preferably corresponds to the predefined initial orientation described above. In order to ensure this, in particular the dimensioning and/or shape of the receiving space can be designed as described above, the positioning of the endless conveyor relative to the bulk material source can be designed as described above, the countersinking of the conveyor trays in the drum can be realized as described above and/or the decrease in size of the receiving space can be realized as described above.

For this purpose, the axis of rotation of the drum is particularly preferably oriented substantially horizontally. Here, “substantially” is to be understood to mean, in particular, a deviation of at most ±30°, 25°, 20°, 15°, 10°, 5°, 3° or 1° from the horizontal. Alternatively or additionally, preferably additionally, the initial orientation corresponds substantially to a horizontal orientation of the bulk material to be singulated, in particular the axis of symmetry of the bulk material to be singulated. In particular in combination with a direction of rotation which, during conveying between the bulk material receiving state and the singulating state, has a movement component which is directed upward in the vertical direction, it is possible here to utilize the weight force of bulk material parts which do not yet lie in the initial orientation at the beginning, in order to drive them into the initial orientation. This functions particularly reliably in the case of bulk material parts which have an extension in the direction of the axis of symmetry of at least twice as large as their maximum extension orthogonally to the axis of symmetry, in particular in the radial direction.

The device preferably has a bulk material source with a bulk material supply which is open toward the endless conveyor. The bulk material supply is preferably designed as described above. The bulk material source preferably furthermore has a conveying means, in particular a conveyor belt, which moves the bulk material in the bulk material source relative to the endless conveyor. The conveying means preferably conveys the bulk material in a conveying direction and extends orthogonally to the conveying direction along a width direction. The bulk material source preferably has a chute which, starting from the conveying means, is inclined downwards in the gravitational direction. The chute, in particular as described above, particularly preferably forms a V-shaped or wedge-shaped bulk material supply space with the drum. The bulk material source preferably has a frame which runs around the conveying means in sections and is interrupted in the region of the chute, with the result that bulk material can pass from the conveying means to the chute. In order to force the bulk material from the conveying means in the direction of the chute, the frame preferably has a ramp which runs transversely over the conveying means in order to decrease the width extent thereof in the conveying direction. In particular, the ramp extends from that side of the conveying means which faces away from the chute in the width direction to that side of the conveying means which faces the chute in the width direction, with the result that the width extension of the conveying means tapers in the conveying direction towards the chute. As a result, bulk material is forced via the ramp to the chute.

A further aspect of the invention relates to a sorting system for the singulated feeding of oriented bulk material parts, in particular ammunition parts with at most one axis symmetry. The sorting system comprises a singulating station for singulating bulk material. The singulating station can be designed like the device, in particular singulating device, described above, wherein the receiving space of the conveyor trays according to the present aspect of the invention may or may not decrease in size during the conveying and/or wherein the endless conveyor according to the present aspect of the invention may or may not have a drum.

According to the present aspect of the invention, the sorting system has an orientation station for the identical orientation of each singulated bulk material. The sorting system furthermore has a transfer station, via which the singulated and oriented bulk material can be transferred to a further processing station. As a result of the possibility according to the invention of orienting each bulk material part identically, the bulk material parts can be transferred in an automated manner to a further processing station, such as the workpiece carrier described below, which enables a fully automated processing of the bulk material parts. This is particularly advantageous in the case of bulk material parts which are axially symmetrical, but have different sides along the axis, in particular a front side and a rear side. This is the case, for example, with ammunition parts, such as cases and projectiles. As a result of the possibility of always orienting them identically, the bulk material parts can be transferred in an automated manner to a workpiece carrier for further processing.

Preferably, the orienting station is designed to transfer the singulated bulk material part from an initial orientation in the singulating station into a target orientation. Preferably, the orienting station for this purpose is designed to transfer bulk material parts with an axis of symmetry, in particular axis of rotational symmetry, into the target orientation by rotating or tilting the axis of symmetry, in particular by 10° to 270°, preferably by 30° to 180°, particularly preferably by 60° to 120°, for example by 90°. In the preferred embodiment, in which the singulating station has an endless conveyor with a drum, around the axis of rotation of which the conveyor trays are arranged in series, the initial orientation preferably corresponds to a substantially parallel orientation of the axis of symmetry of the bulk material part with respect to the axis of rotation of the drum and the target orientation corresponds to an orthogonal orientation of the axis of symmetry of the bulk material part with respect to the axis of rotation of the drum. Particularly preferably, the axis of rotation of the drum is oriented substantially in the horizontal direction.

Preferably, the orienting station has an orienting channel which is configured to taper towards the transfer station in such a way that bulk material parts with a longitudinal axis, in particular axis of symmetry, are forced into a target orientation, in particular under the influence of their weight force, in which the longitudinal axis is oriented towards the transfer station. For this purpose, the orienting channel can preferably taper in the circumferential direction, in particular in the circumferential direction in which the drum rotates during the conveying, in particular singulation.

Preferably, the orienting station is designed to orient each singulated bulk material part independently of the other singulated bulk material parts. The orienting station is preferably designed to orient singulated bulk material parts from conveyor trays which are arranged in series around the axis of rotation of the drum, that is to say bulk material parts which are oriented one after the other, independently of one another. Alternatively or additionally, the orienting station is designed to orient singulated bulk material parts which are singulated in conveyor trays arranged next to one another in the axial direction, that is to say those which are oriented simultaneously in the orienting station, independently of one another.

Preferably, the orientation station for orienting has at least one movable orientation means. In order also to orient the bulk material parts singulated in conveyor trays arranged next to one another simultaneously and independently of one another, the orienting station preferably has at least two, particularly preferably for each row of conveyor trays arranged next to one another in the axial direction, a separate movable orienting means which are movable independently of one another, in particular are movable in different directions.

According to one embodiment, the movable orientation means is a gripper which is designed to grip each singulated bulk material, transfer it from an initial orientation into a target orientation, in particular by rotation, and then release it again, in particular transfer it to the transfer station. In particular, the transfer from the initial orientation into the target orientation is performed by a rotation of 90°.

In an alternative embodiment, the at least one movable orientation means is a tilting gate which can be moved into two positions and which, depending on the position, causes tilting of the bulk material out of the initial orientation in different directions, preferably wherein the tilting gate delimits an orienting channel, in particular the above-described orienting channel, in such a way that said orienting channel tapers from different sides in the two positions of the tilting gate. As a result, the target orientation can be realized by a simple tilting movement, which, in particular in relation to the gripper solution, brings about a significantly increased production capacity, reduced maintenance intensity and increased reliability. In particular, the tilting gate is pivotably mounted at its downstream end in the conveying direction, in particular driven for carrying out a pivoting movement.

The singulating station is preferably designed to singulate bulk material with an axis of symmetry, in particular axis of rotational symmetry, such as cases and/or projectiles, by transferring the axis of symmetry of each bulk material part into a predetermined initial direction. For this purpose, the singulating station can be designed as described above in connection with the singulation apparatuses according to the invention, wherein the aspects according to the invention described above may or may not be realized. It is thereby ensured, in particular, that the singulated bulk material is fed to the orienting station in the predefined initial orientation, with the result that a reliable orientation into the target orientation can be ensured.

The sorting system preferably furthermore has an orientation detection device which is designed to detect an initial orientation of the singulated bulk material in the singulating station, in particular is designed to detect the position of the sides along the axis of symmetry in the case of bulk material with sides which can be distinguished from one another, in particular a front side and a rear side, along the axis of symmetry. The orientation detection device is preferably designed to detect the initial orientation of each singulated bulk material part. In particular, the orientation detection device is designed to detect the individual orientation of each individual bulk material part even in the case of different orientations of bulk material parts singulated in conveying trays which lie next to one another in the axial direction. For this purpose, the orientation detection device can have at least one optical detection unit, in particular at least one camera. The orientation detection device preferably has at least three optical detection devices which are preferably arranged offset with respect to one another in the axial direction. The orientation detection devices are preferably oriented towards the conveying trays which directly follow the conveying trays in the conveying direction, the singulated bulk material parts of which are currently oriented. As a result, the risk of the initial orientation of the bulk material parts changing after the detection and before the orientation in the orienting station can be avoided.

The sorting system preferably furthermore has a controller which is designed to control the orientation station differently in the case of different initial orientations, in particular of the bulk material parts. For this purpose, the controller preferably receives signals corresponding to the different initial orientations, in particular from the orientation detection device described above. Preferably, the controller is designed to control the movable orienting means described above simultaneously and/or independently of one another.

The singulating station is preferably designed to feed at least two, preferably at least three, four, six, eight, ten or twelve, singulated bulk material parts simultaneously to the orienting station. For this purpose, the singulating station is preferably designed as described above in connection with one or both aspects of the invention relating to the singulation apparatus.

Preferably, the orienting station is designed to orient the at least two, preferably at least three, four, six, eight, ten or twelve, singulated bulk material parts simultaneously and independently of one another, the orienting station for this purpose preferably having at least two, in particular at least three, four, six, eight, ten or twelve, movable orienting means, in particular as described above.

A further aspect of the invention relates to a sorting system for the singulated feeding of oriented bulk material parts, in particular ammunition parts with at most one axis symmetry. The sorting system can be designed as described in connection with the aspect of the invention described above with respect to the sorting system, wherein the orienting station may or may not be suitable for the identical orientation of each singulated bulk material part. The sorting system comprises a singulating station for singulating bulk material. The singulating station can be designed like the singulating device as described in connection with the aspects of the invention relating thereto, wherein the conveyor trays thereof may or may not have a receiving space which decreases in size during the conveying and/or wherein the endless conveyor may or may not have a drum.

According to this aspect of the invention, the sorting system has a transfer station with at least one chute track, via which the singulated bulk material part, under the influence of its weight force and while maintaining its singulation, can be transferred to a further processing station. In order to utilize the weight force, the chute can be inclined downwards with respect to a horizontal in the vertical direction. To maintain the singulation of the bulk material part, the chute track can have chute channels which are adapted to the dimension of the bulk material to be singulated in such a way that only one bulk material can pass through a channel at the same time. Furthermore, in the case of a design of the singulating station for the simultaneous singulation of a plurality of bulk material parts, a plurality of chute channels can be configured which are designed to maintain the singulation of each singulated bulk material. For this purpose, each chute channel can have boundary walls which prevent a transfer from one chute channel into the other. In particular, the chute channels can each have a channel base and channel side walls projecting from the channel base. The channel side walls can extend orthogonally from the channel base, in particular extend upwards in the vertical direction. In particular, the channel walls and the channel base can define a U-shaped cross section of the chute channels.

Preferably, the at least one chute track is adapted to the dimension of the bulk material in such a way that the separating bulk material part passes through the chute track in a predetermined orientation. In particular, for this purpose, the distance between the channel side walls of the chute track can be designed to be smaller than the extension of the bulk material parts in the initial orientation direction, in particular in the direction of their axis of symmetry, in particular axis of rotational symmetry. It can thereby be ensured, in particular, that a bulk material part oriented along its axis of symmetry cannot tilt by 90°, with the result that a rotation of the bulk material part out of the target orientation is avoided. The chute channels preferably taper in the direction of the further processing station in such a way that play for possible tilting movements of the axes of symmetry of the bulk material parts is reduced. Particularly preferably, the distance between the side walls delimiting the chute channels in the region of the loading devices described below is reduced in such a way that the distance is at most 30%, 25%, 20%, 15% or 10% greater than the greatest radial extent of the bulk material parts. It can thereby be ensured that no tilting, or at least no significant tilting, of the bulk material parts can occur in the region of the loading device, in particular that the bulk material parts are forcibly oriented in the region of the loading device. The distance between the side walls delimiting the chute channels is preferably also in the region of the loading device greater than the maximum radial extension of the bulk material parts, in particular at least 1%, 2%, 3%, 5% or 10% greater than the radial extension, in order to avoid jamming of the bulk material parts in the chute channels.

The chute preferably has an acceleration section which is inclined in the gravitational direction and in which the bulk material part is accelerated under the influence of its weight force, and an outlet section which is inclined less strongly in the gravitational direction with respect to the acceleration section, in particular is oriented substantially horizontally, and in which the bulk material part is decelerated. The acceleration section is preferably of arcuate design. In particular, the acceleration section has, in the conveying direction, an acceleration start which adjoins the singulating station and an acceleration end which adjoins the outlet section. The acceleration start preferably has an inclination with respect to the horizontal, in particular measured on the basis of a tangent at the acceleration start, of between 30 and 90°, preferably between 50 and 80°, particularly preferably between 60 and 70°. The acceleration end preferably has an inclination with respect to the horizontal of less than 20°, 15°, 10°, 5°, 3° or 1°, in particular is oriented horizontally.

The singulating station preferably has a drum, in particular as described above, by means of which the bulk material can be singulated in a multiplicity of conveying trays and can be fed to the transfer station, in particular the chute track. The axis of rotation of the drum is preferably oriented horizontally. Particularly preferably, the singulating station transfers the singulated bulk material to the transfer station in a transfer section which preferably extends between an uppermost region, in the vertical direction, of the drum, in particular of the drum coat, and a region which is offset with respect to the uppermost region by 90° about the axis of rotation of the drum, in particular in the conveying direction. The transfer section is preferably used as a pre-acceleration section. The transfer section preferably extends in an arcuate manner, in particular in a complementary manner to the arcuate profile of the drum coat. The pre-acceleration section particularly preferably has at least one pre-acceleration channel, along which the singulated bulk material can be accelerated under the influence of its weight force and while maintaining its singulation in the direction of the transfer station, in particular the chute track. The pre-acceleration channel preferably has at least one base which is formed in particular by the drum coat, and at least two side walls which are preferably formed by arcuate ribs which run, in particular above, the drum coat along the contour thereof. The pre-acceleration channel and the chute track channel preferably merge into one another. The pre-acceleration channel and the chute track channel particularly preferably form an S-shaped channel profile. The orienting station described above is preferably arranged in the region of the vertex of the S-shaped channel. “In the region” is preferably to be understood to mean a region, as seen in the conveying direction, of ±300 mm, 250 mm, 200 mm, 150 mm, 100 mm, 80 mm, 50 mm, 30 mm, 20 mm, 10 mm or 5 mm from the vertex. Preferably, the movable orienting means of the transfer station described above, in particular the tilting gate described above, is arranged in the S-shaped channel. Particularly preferably, the tilting gate is arranged centrally in the channel, in particular with respect to the axial direction of the drum, and can be tilted against both of the side walls, in particular ribs, delimiting the respective acceleration channel. The acceleration channel preferably tapers from the transition from the pre-acceleration section into the acceleration section, in particular to an axial extension which preferably corresponds substantially to the greatest radial extension of the bulk material to be singulated. The orienting channel particularly preferably widens again in front of the outlet section, in particular in order to avoid jamming in this region. In the outlet section, the orienting channel preferably tapers again, in particular to an axial extension which preferably corresponds substantially to the greatest radial extension of the bulk material to be singulated. Substantially is in each case to be understood to mean, in particular, that the axial extension of the channels is at most 30%, 25%, 20%, 15% or 10% greater than the greatest radial extension of the bulk material parts.

The transfer station preferably has a loading apparatus which receives the singulated bulk material part from the chute track and is designed to transfer it into the further processing station, in particular in the form of a workpiece carrier movably guided past the sorting system. The loading device preferably has at least one loading channel which preferably adjoins at least one of the chute track channels described above, in particular adjoins them in such a way that the singulated bulk material parts pass into the loading channel, in particular slide, in particular pass into the loading channel as a result of the acceleration in the region of the acceleration section, and are preferably decelerated by the outlet section which adjoins the acceleration section in such a way that they come to a standstill in the region of the loading channel.

The loading apparatus preferably has a pusher which is designed to push the singulated bulk material part into a receptacle, in particular adapted thereto, of a further processing station. For this purpose, the pusher preferably has, above the loading channel, a drop flap which is designed to allow a bulk material part coming from the chute track to pass through and to carry it along during a subsequent movement of the pusher in the direction of the processing station, in particular to push it in the direction of the processing station. For this purpose, the drop flap is preferably pivotably fastened to the pusher, in particular fastened above the chute track to the latter, in particular pivotably fastened in such a way that the rocker arm projects, in particular caused the gravitational force, into the loading channel, and is pivoted out of the loading channel, in particular counter to the direction of gravity, by a bulk material part coming from the chute track. Preferably, the rocker arm is designed in such a way that, after passing of the bulk material part, it moves back into the loading channel, in particular is driven back into the channel by its gravitational force. The rocker arm preferably furthermore has a contact edge which is designed with respect to the axis of rotation of the rocker arm in such a way that, during a movement of the pusher in the direction of the loading apparatus, the rocker arm is not pivoted out of the loading channel, but transmits the relative movement of the pusher to the bulk material part, in particular pushes the bulk material part into the receptacle of the processing station.

The pusher is preferably movable with respect to the workpiece carrier and/or, preferably and, with respect to the loading channel, in particular movable in the horizontal. Particularly preferably, the pusher is movably mounted via two bolts. In particular, the pusher is driven via an actuator, in particular a linear motor. The pusher is preferably arranged above the at least one loading channel described above.

The singulating station is preferably designed to feed at least two, preferably at least three, four, six, eight, ten or twelve, singulated bulk material parts simultaneously to the transfer station. For this purpose, the singulating station is preferably designed as described above.

The sorting system preferably has at least two, preferably at least three, four, six, eight, ten or twelve, chute tracks, in particular in one chute track per bulk material singulated simultaneously by the singulating station, via which the singulated bulk material parts, under the influence of their weight force and while maintaining their singulation, can be transferred simultaneously to a further processing station. For this purpose, each of the chute tracks is preferably designed as described above and particularly preferably has in each case one chute track channel and preferably one pre-acceleration section, in particular as described above. Preferably, a movable orienting means, in particular as described above, is assigned to each of the chute tracks upstream of the conveying direction. A movable orienting means, in particular a tilting gate, in particular as described above, is particularly preferably formed in each of the above-described S-shaped chute tracks which are formed between chute track and pre-acceleration section. The individual chute tracks preferably converge in the direction of the further processing station, in order to bring the singulated bulk material parts closer to one another while maintaining their singulation. As described above, the bulk material parts in the region of the singulating station, in particular the axis of symmetry thereof, are preferably oriented parallel to the axis of rotation of the drum and are subsequently rotated by 90° in the orienting station. In the case of the bulk material parts which are preferably to be singulated and to be orientated and which have a greater extension along their axis of symmetry than orthogonally thereto, the singulated bulk material parts can be arranged next to one another in a smaller space by the abovementioned rotation. As a result of the chute tracks converging on one another, use is made of this circumstance in order to be able to arrange the singulated bulk material parts in as small a space as possible and to transfer them to a further processing station, in particular workpiece carrier, which is as small as possible.

The transfer station preferably has a loading apparatus which receives the singulated bulk material parts from the chute tracks and is designed to transfer them simultaneously to the further processing station, in particular in the form of a workpiece carrier movably guided past the sorting system. For this purpose, the loading apparatus preferably has a pusher which is designed as described above. The pusher particularly preferably has, for each of the chute tracks, a tilting gate via which each singulated bulk material can be pushed into the workpiece carrier via its own loading channel.

The invention furthermore relates to a system for producing ammunition which has a case, an ignition element and a projectile. The system can also be referred to as an ammunition production system. The system comprises at least one sorting system according to one or both of the aspects of the invention described above relating to the sorting system, and/or at least one singulating device according to one or both of the aspects of the invention described above in this respect. The sorting system is designed for singulating at least one ammunition part, in particular the case and/or the projectile.

The system preferably has at least two sorting systems which can each be designed like the at least one sorting system described above, in order to singulate a case or a projectile, in particular a case, with one sorting system and a further ammunition part, in particular a projectile, with the other sorting system. For this purpose, the two sorting systems are preferably adapted in each case to the geometry and dimension of the ammunition parts to be singulated, in particular the projectile and/or the case.

The system furthermore preferably has an ignition element insertion station for inserting an ignition element into the case. The system furthermore preferably has a propellant filling station for filling the case with propellant powder. The system furthermore preferably has a projectile assembly station for placing the projectile onto the case. The system furthermore preferably has a circulating conveying system for transporting in a plurality of the ammunition parts, in particular a plurality of cases and/or projectiles, to, from or between a plurality of production stations. The circulating conveying system preferably has at least one, preferably a multiplicity of, workpiece carriers which is guided past the at least one sorting system in such a way that it is loaded, in particular charged, with the singulated ammunition parts via its transfer station.

The system can have a plurality of production or processing stations at which the different assembly or production steps are carried out. By way of example, the plurality of production stations comprise an ammunition part insertion station, preferably a case insertion station and/or a projectile insertion station, for inserting at least one of the plurality of ammunition parts into the production process of the system, a plurality of quality testing stations, at least one ammunition part processing station, for example a case forming station, a propellant filling station, a projectile assembly station, a projectile marking station and/or an ejection station for transporting the produced ammunition out of the production process of the system. The ejection station can also serve to eject rejects from the production process. The plurality of production stations can be arranged in relation to the production process in such a way that the ammunition parts can be fed one after the other to the production stations, in order to allow the production steps building on one another to be carried out.

The system can furthermore have one or more workpiece carriers for holding a plurality of the plurality of ammunition parts and for transporting in a plurality of the plurality of ammunition parts to, from and/or between the plurality of production stations. The workpiece carrier, which can also be referred to as a conveyor device, accordingly performs at least two functions. On the one hand, the workpiece carrier can hold the ammunition parts necessary for the ammunition and enable an access of the individual production stations to the ammunition parts or enable a processing of the ammunition parts at the individual production stations and, on the other hand, the conveyor device is responsible for the in particular automated transporting or conveying of the individual ammunition parts along the production process defined by the plurality of production stations. In particular, the workpiece carrier defines a closed circulating conveying track along which the individual ammunition parts are conveyed at least in sections, depending on their influence on the production process, and which delimits an interior space enclosed by the conveying track and an exterior space delimited therefrom. The conveyor track can have an endless racetrack-like structure or shape. In particular, the system comprises a plurality of workpiece carriers, such as slides, which are distributed along the conveyor track and are in particular of identical design. The plurality of workpiece carriers can be actuated individually and moved along the conveyor track, so that individual production stations can be approached with an individual movement profile per workpiece carrier. The production process is thus considerably more flexible than when the workpiece carriers are fixed to one another along the conveyor track.

At least one, in particular a plurality, of the plurality of production stations can be arranged in the interior space and/or the exterior space and can act from the inside and/or from the outside on the workpiece carrier, in particular on the ammunition parts conveyed or transported along the conveying direction. The lateral or horizontal action plane, created in this way, of the production stations on the workpiece carriers or on the ammunition parts conveyed therewith enables a space-saving, cleaned-up construction of the system. With such a lateral access to the conveyor device, the high demands on the production capacity can be better satisfied, since, as a result of the lateral arrangement with the lateral access of the production stations to the workpiece carriers, the individual production stations can be designed completely independently of the workpiece carriers and can be positioned, repositioned and exchanged freely or flexibly in relation to the conveyor device.

The plurality of workpiece carriers can furthermore be moved independently of one another from, to and/or between the plurality of production stations. In particular, the system comprises a plurality of workpiece carriers, such as slides, which are distributed along a conveyor track and are in particular of identical design. The plurality of workpiece carriers can be actuated individually and moved along the conveyor track, so that individual production stations can be approached with an individual movement profile per conveyor device. The production process is thus considerably more flexible than when the workpiece carriers are fixed to one another along the conveyor track.

The system can furthermore have at least two propellant filling stations arranged one behind the other in the conveying direction. The propellant filling stations are in principle designed to fill ammunition parts, in particular the case, with propellant powder. The propellant filling station can be designed on the basis of gravimetry or can operate on the basis of volumetric metering. Advantages with regard to the accuracy of the metering quantity can be achieved with the gravimetric metering. Significant advantages with regard to the processing speed can be achieved with the volumetric metering, which has a positive effect on the cycle rate, in particular during the integration of the propellant filling station into a system for the automated production of ammunition. The device serves in particular for the simultaneous filling of the at least two ammunition cases with propellant powder. This means that the filling of the at least two ammunition cases is carried out in a filling operation, in particular without a change of direction by more than 90°. Simultaneously is not necessarily to be understood here to mean that the at least two ammunition cases are filled exactly at the same time, but rather that there is quite a certain time offset between the filling, in particular the complete filling, of the ammunition cases arranged along the path. The device can be designed to fill the at least two ammunition cases in each case with a defined, in particular substantially identical, quantity taking into account the process-inherent inaccuracies. The propellant powder can be, for example, a propellant powder for a small-caliber ammunition, in particular with a caliber in the range of 4.5 mm to 13 mm, which typically has one-or two-based spherical, tubular, rod or flake shapes and/or is shaped in the manner of a powder. Alternatively, extruded propellant powders can also be used. If the propellant powder is spherical, it can be rolled, for example, and can have a sphere diameter of 0.4 mm to 0.8 mm. In the case of rod-shaped propellant powder, for example for the 5.56 mm caliber ammunition, the rods can have a length of up to 1.1 mm and/or a diameter of up to 0.7 mm. The density of the propellant powder used can be, for example, in the range from 0.5 to 1 g/cm3 in the case of nitrocellulose (NC). In the case of such a propellant powder, the bulk density lies in the range from 0.6 to 1 g/cm3, for combat cartridges, for subsonic or blank cartridges, at up to 0.4 g/cm3.

One of the plurality of production stations can furthermore be an ignition element insertion station which brings an ignition element into the production process of the system and inserts it into a case. The ignition element insertion station can be designed to insert a plurality of, in particular at least two, three, four, five, six, seven, eight, nine, ten, eleven or twelve, ignition elements simultaneously, in particular in one insertion operation, into a corresponding number of cases.

One of the plurality of production stations can furthermore be a fluid application station in which a sealing compound is applied in an annular joint between the case and the ignition element received therein and/or between the case and the projectile inserted therein, and the annular joint is sealed and/or marked. It has been found that the integration of the application of the sealing compound in the automated production process entails considerable advantages with regard to the production capacity and also the production accuracy. As a result of the system ensuring that the individual components are oriented with respect to one another, the fluid application station can benefit from this predetermined orientation of the individual components with respect to one another and apply the sealing compound very precisely.

One of the plurality of production stations can furthermore be a quality monitoring station in which the case and the projectile are in particular in each case individually monitored before assembly. The monitoring can be understood to mean a quality control with regard to predetermined parameters.

The workpiece carriers and the production stations can furthermore be coordinated with one another in cycles, wherein at least two, at least five, at least ten or at least twelve ammunition parts are processed into ammunition per cycle at the production stations. The production capacity is achieved, inter alia, by the parallel processing of a multiplicity of ammunition parts per cycle.

The conveyor track can furthermore have a rail which is oriented in the direction of the interior space and/or exterior space and runs along the conveyor track and fixes a coupling interface of the conveyor device in a provision position.

The invention further relates to the use of a singulating device, according to one or both of the aspects of the invention relating thereto, and/or a sorting system according to one or both of the aspects of the invention relating thereto, for the singulated feeding of ammunition parts, in particular to a workpiece carrier.

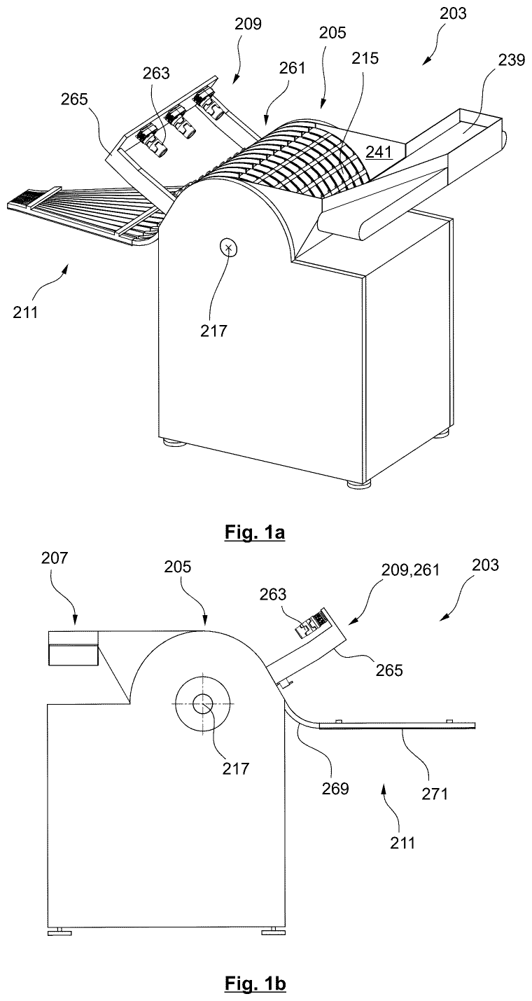

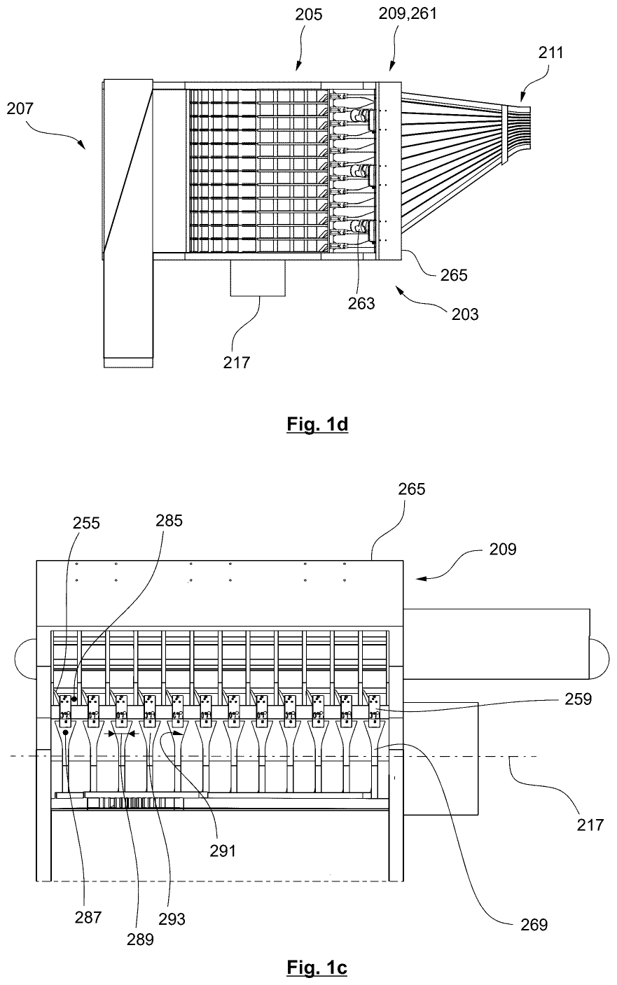

FIG. 1A shows a perspective view of a sorting system according to the invention with a singulating station;

FIG. 1B shows a side view of the sorting system from FIG. 1A;

FIG. 1C shows a front view of the sorting system from FIG. 1A;

FIG. 1d shows a bird's eye view of the sorting system from FIG. 1A;

FIG. 1E shows an enlarged view of orientation means from FIG. 1A;

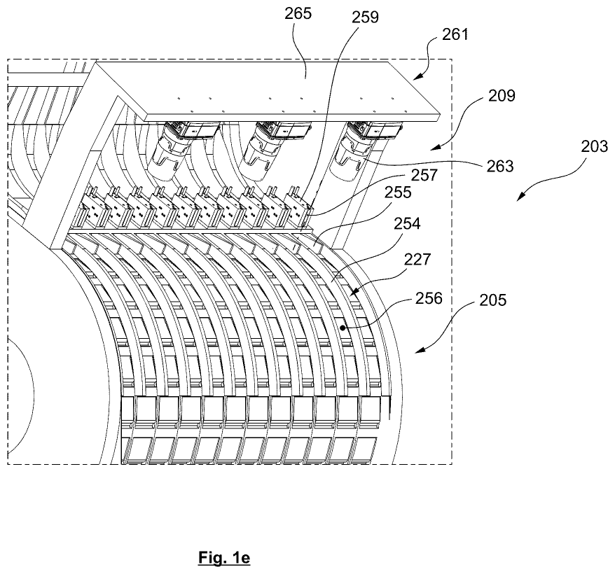

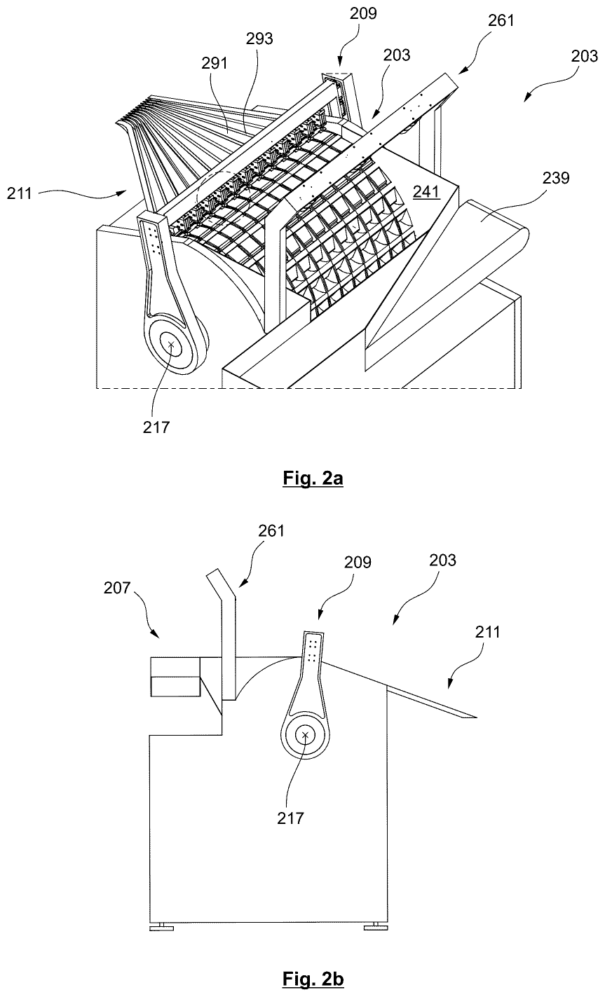

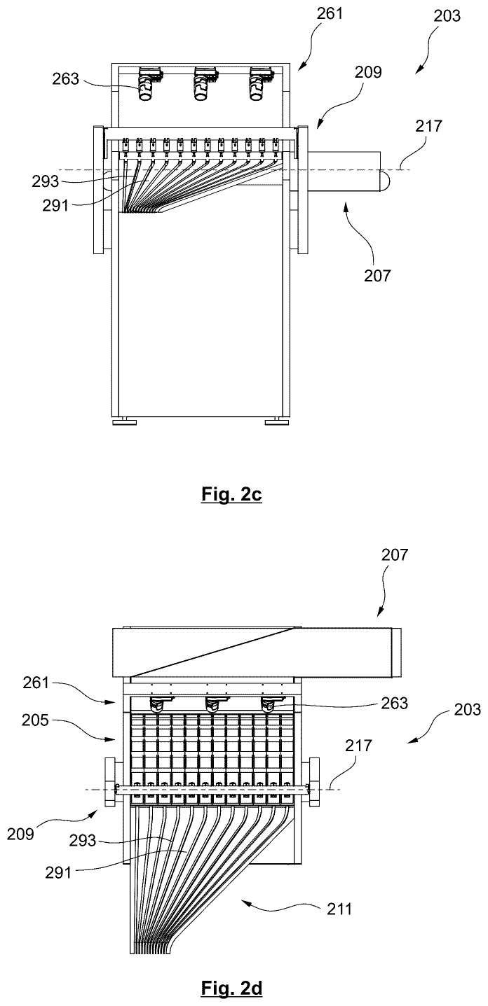

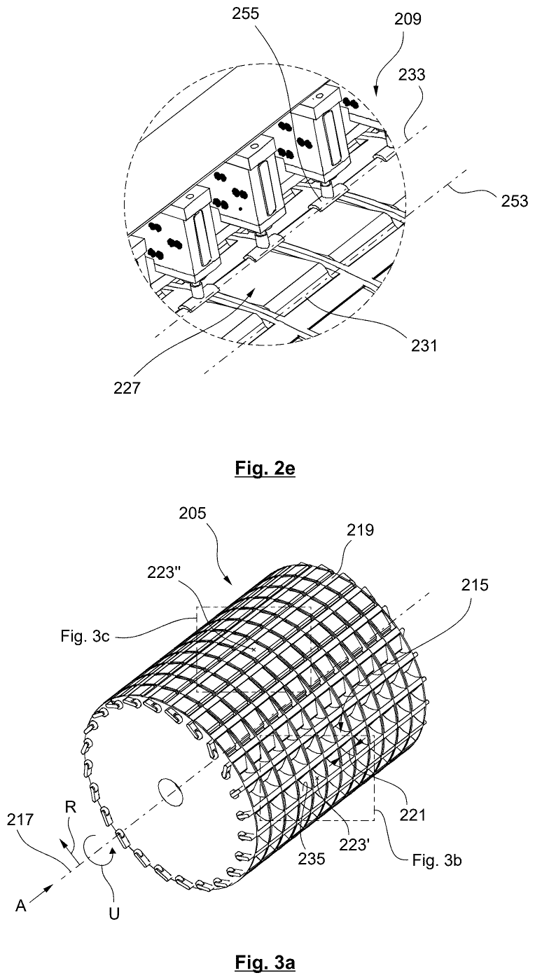

FIG. 2A shows a perspective view of an alternative embodiment of a sorting system according to the invention with a singulating station;

FIG. 2B shows a side view of the sorting system from FIG. 2A;

FIG. 2C shows a front view of the sorting system from FIG. 2A;

FIG. 2D shows a bird's eye view of the sorting system from FIG. 2A;

FIG. 2E shows an enlarged view of orientation means from FIG. 2A;

FIG. 3A shows a perspective view of the drum from FIGS. 1A to 2E;

FIG. 3B shows an enlarged view of a section of the drum from FIG. 3A;

FIG. 3C shows an enlarged view of another section of the drum from FIG. 3A;

FIG. 4 shows a perspective view of the sorting system from FIG. 1A with a charging station and workpiece carrier;

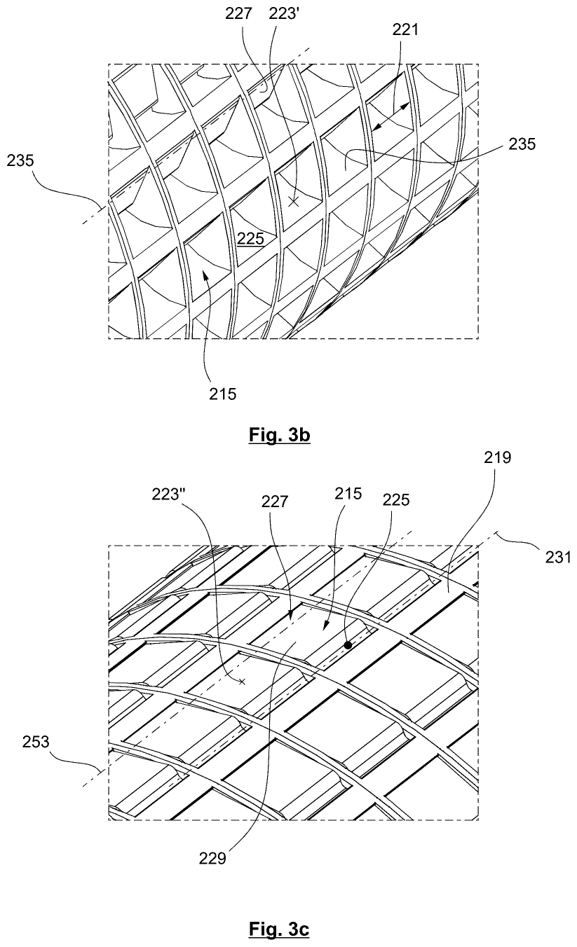

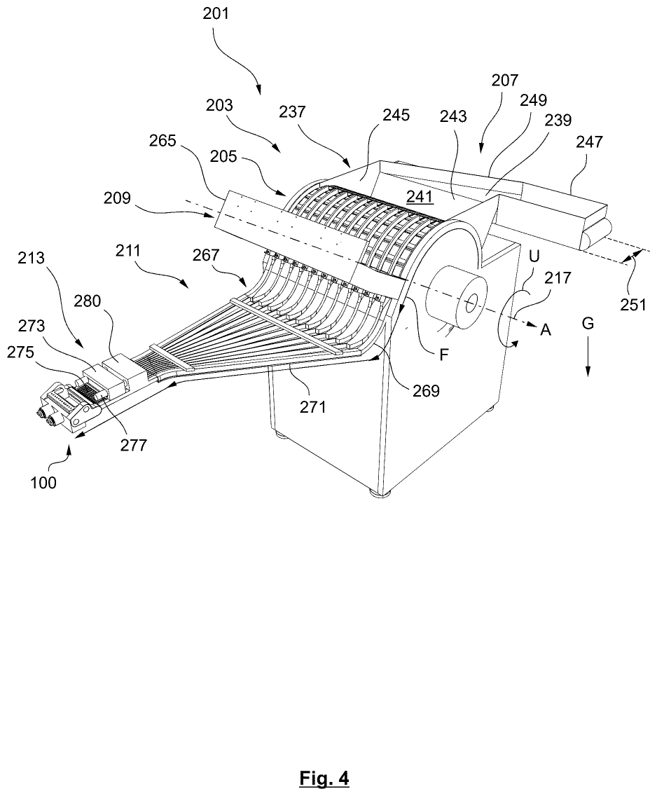

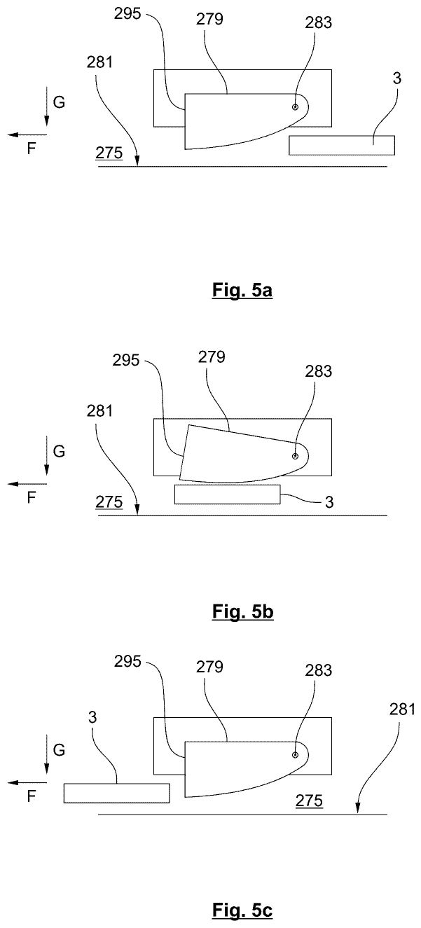

FIG. 5A shows an exemplary, schematic illustration of the inside of the charging station from FIG. 4 with a drop flap and an ammunition part in front of the drop flap;

FIG. 5B shows an exemplary, schematic illustration of the inside of the charging station from FIG. 4 with a drop flap and an ammunition part at the height of the drop flap;

FIG. 5C shows an exemplary, schematic illustration of the inside of the charging station from FIG. 4 with a drop flap and an ammunition part behind the drop flap;

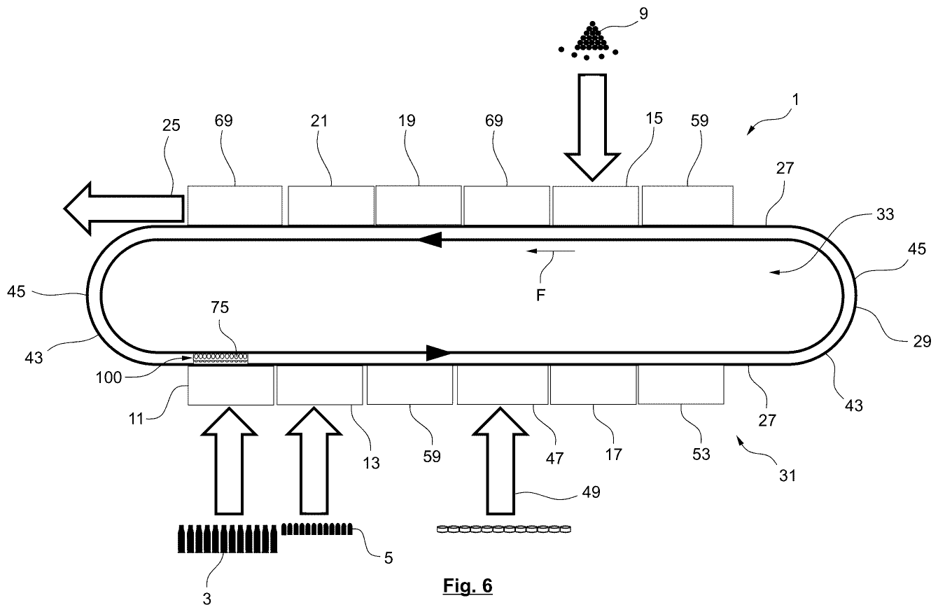

FIG. 6 shows a schematic drawing of an exemplary embodiment of an ammunition production system;

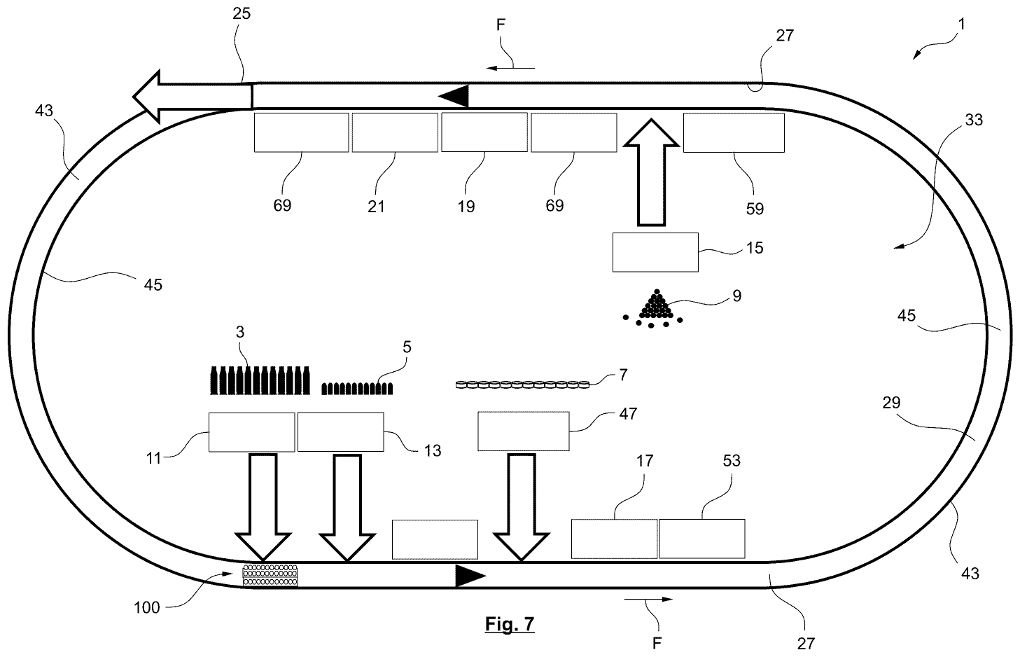

FIG. 7 shows a schematic drawing of an alternative exemplary embodiment of an ammunition production system;

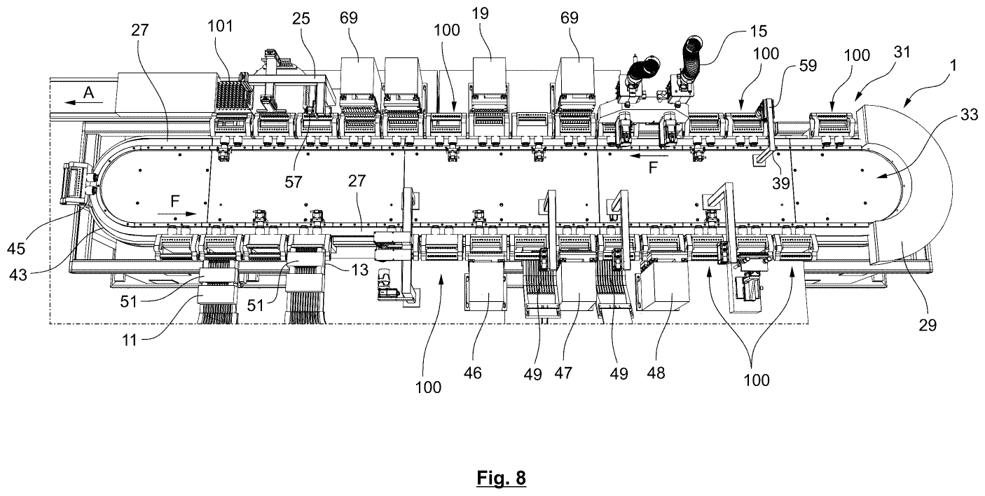

FIG. 8 shows a schematic drawing with a greater depth of detail of a further exemplary embodiment of an ammunition production system;

In the present description of exemplary embodiments of the present inventions, a system for producing ammunition, also called ammunition production system or laboratory system, is generally provided with the reference sign 1. A workpiece carrier for holding and for transporting the plurality of ammunition parts to and from a plurality of production stations is generally identified by the reference sign 100; The finished ammunition is identified by the reference sign 101;

According to the exemplary embodiments of the laboratory system 1 in FIGS. 6-8, the laboratory system 1 comprises the following production stations: a sorting system in the form of a case insertion station 11, with which bulk material in the form of a case 3 is singulated and oriented and then transferred to the workpiece carrier 100; and a sorting system in the form of a projectile insertion station 13, with which bulk material in the form of a projectile 5 is singulated and oriented and then transferred to the workpiece carrier 100. Furthermore, the laboratory system 1, as illustrated, can comprise the following further production stations: a propellant filling station 15 which is designed to fill cases 3 with propellant powder 9; a case mouth expansion station 46; an ignition element feed station 49 for feeding ignition elements 7; an ignition element insertion station 47 for inserting one of the ignition elements 7 into the cases; an ignition element caulking station 48; a case mouth sealing station 57; a plurality of quality monitoring stations 59 and quality testing stations 69 for visually and/or tactilely ensuring the quality of the ammunition 101; and an ejection station 25 for finally ejecting the finished ammunition 101.

The workpiece carrier 100 is part of a conveying system which conveys the workpiece carrier between the plurality of production stations 11, 13, 15, 59, 59, 25 along a closed circulating conveying track 29 which delimits an interior space 33 enclosed by the conveying track 29 and an exterior space 31 delimited therefrom. According to the exemplary embodiment in FIGS. 6-8, the conveyor track 29 is constructed from two parallel linear sections 27, which are connected by curved sections 43 in order to form a racetrack-shaped conveyor track profile. The production stations are arranged laterally with respect to the conveying direction E in the interior space 33 (FIG. 6) or in the exterior space 31 (FIG. 7) of the conveyor track 29.

With reference to FIGS. 6 and 7, schematic drawings of exemplary embodiments of a system 1 can be seen. FIG. 6 shows a system arrangement in which the ammunition components are introduced into the workpiece carrier 100 from the outside. FIG. 7 shows the reversed approach in which the ammunition components are brought from the interior space 33 into the workpiece carrier 100. The principal production sequence is the same in both system arrangements according to FIGS. 6 and 7. Both system principles have the following production sequence: via a curved section 43, a workpiece carrier 100 located in a buffer zone 45 is fed to the case insertion station 11. This is followed by the projectile insertion station 13, in which the projectiles 5 are fed to the workpiece carrier 100. The entire workpiece carrier 100 with the projectiles 5 and cases 3 located thereon is then subjected to an optical inspection in a quality monitoring station 59. In the subsequent stations, an ignition element 7 is first introduced into the system 1 via an ignition element feed station 49, in order then to be transferred with a slide 51 into an ignition element insertion station 47, in order to be finally introduced into the tail of the case 3. After the insertion, the cases 3 are calibrated at a case forming station 17 and then sealed with annular joint lacquer at a fluid application station 53. The workpiece carriers 100 are then guided over a second curved section 43, after which a linear section 27 with a plurality of production stations follows again. Before the cases 3 are filled with propellant powder 9 at the propellant filling station 15, a quality monitoring station 59 checks whether the ignition elements 7 were received correctly in the cases 3. After the filling, the filling level is checked, in particular tactilely, at a quality testing station 69. The actual assembly of projectile 5 and case 3 takes place in two stages; first, the projectile 5 is brought onto the case 3 only slightly at the projectile insertion station 19, in order finally to be pressed into the case 3 at the projectile assembly station 21 in the subsequent step. The ammunition 101 finalized as a result is then also checked at a quality monitoring station 59 and/or a quality testing station 69 and then ejected via an ejection station 25.

FIG. 8 shows a detailed illustration of the system 1. In order to increase the production capacity or the production safety, it is possible for the system 1 to have at least two propellant filling stations 15 arranged one behind the other in the conveying direction. As a result of this special arrangement, two workpiece carriers 100 can be filled alternately with propelling charge powder 9. As a result, the propellant powder has more time per cycle to trickle into the case 3, which leads to an increased metering accuracy. In the case of the system 1, labor-intensive stations can generally be designed twice, so that the workload of a station is correspondingly halved. One example of a labor-intensive step is the feeding and insertion of ignition elements 7 into the tail of the case 3. For this purpose, FIG. 8 shows an exemplary development of the system 1, in which two ignition element feed stations 49 for equipping the ignition element insertion station 47 with ignition elements 7 are arranged one behind the other in the conveying direction. In FIG. 8, the ignition element insertion station 47 is arranged between the ignition element feed stations 49 in the conveying direction E. This has the advantage that the production capacity can be significantly increased since operations can be carried out in parallel.

FIGS. 6 to 8 schematically indicate the sorting systems according to the invention and the singulating devices according to the invention. FIG. 4 shows a preferred embodiment of a sorting system 201 according to the invention with a singulating device 203 according to the invention. The singulating device 203 has an endless conveyor 205 in the form of a drum, as shown in FIGS. 3A to 3C. The conveying direction of singulated bulk material parts is identified by the arrow F in FIG. 4. A bulk material source 207 is arranged upstream of the endless conveyor 205 in the conveying direction. An orienting station 209 is arranged downstream of the endless conveyor 205 in the conveying direction. A transfer station 211, via which the singulated bulk material part is transferred to a loading device 213, is arranged downstream of the orienting station 209 in the conveying direction. The singulated bulk material part is transferred to the workpiece carrier 100 via the loading device 213.

As can be seen in particular from FIG. 1A, the endless conveyor 205 is arranged with respect to the bulk material source 207 in such a way that bulk material falls under the influence of its weight force G into conveyor trays 215, in particular being arranged in series, which are conveyed past the bulk material source. For this purpose, the endless conveyor 205 has a drum 205, around the axis of rotation 217 of which the conveyor trays 215 are arranged in series. The direction parallel to the axis of rotation 217 is referred to below as the axial direction A. In the axial direction A, a plurality of rows of conveyor trays 215 are arranged next to one another, in particular arranged in alignment next to one another, such that, in addition to the rows of conveyor trays arranged in the circumferential direction U around the axis of rotation 217, rows of conveyor trays extending in the axial direction A are formed. As can be seen in particular from FIG. 3A, the conveyor trays 215 are formed by cutouts in the drum 205 which, proceeding from a drum coat 219, extend inward in the radial direction R (with respect to the axis of rotation 217). In the embodiment illustrated, the endless conveyor 205 has twelve rows of conveyor trays 215 extending around the axis of rotation 217, which rows are arranged next to one another in the axial direction A. As can be seen in particular from FIG. 3B, the distance between the conveyor trays 215 in the circumferential direction U (with respect to the axis of rotation 217) and in the axial direction A is smaller than the extension 221 of the conveyor trays 215 in the axial direction. The axial extension 221 of the conveyor trays 215 is adapted to the axial extension of the bulk material to be singulated, in particular along its axis of symmetry, in particular axis of rotational symmetry. In particular, the axial extension 221 of the conveyor trays 215 is somewhat greater than the axial extension of the bulk material parts to be singulated, with the result that these are driven under the influence of their weight force into a lying position (axis of symmetry parallel to the vertical) and into an orientation parallel to the axis of rotation 217 of the drum 205.

FIGS. 3B and 3C show close-ups of the conveying trays 215 in different circumferential positions 223′, 223″. FIG. 3B shows a conveyor tray 215 in the position 223′ identified in FIG. 3A, while FIG. 3C shows a conveyor tray in the downstream circumferential position 223″ illustrated in FIG. 3A. As can be seen from the comparison of FIGS. 3B and 3C, the receiving space 225 for the bulk material decreases in size during the conveying from the circumferential position 223′ to the circumferential position 223″. FIG. 3B shows the conveyor tray 215 in a bulk material receiving state, in which a multiplicity of, in particular identical, bulk material parts fit into the receiving space 225. FIG. 3C shows the conveyor tray 215 in a separating state, in which only a separated bulk material fits into the receiving space 225. The receiving space 225 in the singulating state is adapted to the shape of the bulk material parts in such a way that separated bulk material parts are forced into a predefined initial orientation. For this purpose, the receiving space 225 has a cylindrical section shape in the singulating state. The cylindrical section shape is delimited by a tray wall 227 which has a planar surface 229 with respect to which a recess 231 is recessed in the radial direction R with respect to the axis of rotation of the drum 205. The recess 231 (depression 231) is formed by a cylinder coat section which, proceeding from the planar surface (planar section) 229, extends inward in the radial direction R, in particular in the shape of a cylinder section.

As can be seen from the comparison of FIGS. 3B and 3C, the receiving space 225 decreases in size in such a way that bulk material located beyond a separated bulk material part in the receiving space 225 is pushed out of the latter. For this purpose, the conveyor trays 215 each have a movable tray wall 227 for decreasing the size of the respective receiving space 225. The movable tray wall 227 has the planar section 229 described above and the recess 231. The tray walls 227 are pivotable about a pivot axis 233, which is shown schematically in FIGS. 3B and 3C. As can be seen from the comparison of FIGS. 3B and 3C, the respective tray wall 227 pivots outward in the radial direction R from the bulk material receiving state into the separating state, with respect to the axis of rotation 217. The conveyor trays 215 furthermore each have a concavely shaped tray base 235, with respect to which the respective tray wall 227 is movable, in particular pivotable. In particular as a result of the pivotable tray wall 227, the receiving space 225 decreases in size during conveying from the bulk material receiving state into the separating state.

The bulk material source 207 has a bulk material supply 237 which is open toward the endless conveyor 205 and a conveying means 239, in particular a conveyor belt 239, which moves the bulk material in the bulk material source 207 relative to the endless conveyor 205. The bulk material supply 237 delimits a bulk material supply space 241 which is open toward the endless conveyor 205. The bulk material supply space 241 tapers in the gravitational direction G. The bulk material supply space 241 is delimited on mutually opposite sides, on the one hand, by a chute 243 of the bulk material supply and, on the other hand, by the drum 205 of the endless conveyor 205. In the axial direction A, the bulk material supply 237 is preferably delimited by face-side walls 245 of the bulk material supply 237. As can be seen in particular from FIG. 4, the bulk material supply space 241 or the bulk material supply 237 tapers in a wedge-shaped manner, in particular in a V-shaped manner, in the gravitational direction G.

The conveyor belt 239 adjoins an upper section, in particular end, of the chute 243, with the result that bulk material conveyed along the conveyor belt 239 can pass via the chute 243 into the bulk material supply space 241. The conveyor belt 239 is surrounded by a frame 247 which is open toward the chute 243. The frame 247 has a ramp 249 which extends transversely over the conveyor belt 239, with the result that the width 251 (orthogonally with respect to the conveying direction of the conveyor belt 239) of the conveyor belt 239, on which bulk material can be located, decreases in size in the conveying direction F of the conveyor belt 239. As a result of the illustrated arrangement of the endless conveyor 205 with respect to the bulk material source 207, it is ensured that bulk material falls under the influence of its weight force into conveyor trays 215 of the endless conveyor 205 which are conveyed past the bulk material source 207. In particular, as a result of the formation of the conveyor trays 215 as cutouts in the drum coat 219 inward in the radial direction R, it is ensured that, when the conveyor trays 215 are conveyed past the bulk material source 207, bulk material falls under the influence of its weight force into the conveyor trays 215 which are conveyed past the bulk material source. The singulating of the bulk material is ensured by the subsequent decrease in size of the receiving space 225 of the conveyor trays 215.

The orienting station 209 from FIG. 4 is shown in FIG. 1E from the other side. An alternative embodiment of the orienting station 209 is shown in FIG. 2E. Both orienting stations 209 are designed for the identical orientation of each singulated bulk material part. For this purpose, both singulating stations 203 transfer a singulated bulk material part from an initial orientation into a target orientation. In the present case, the initial orientation corresponds to the orientation of the axis of symmetry of a bulk material part parallel to the axis of rotation 217 of the drum 205. In the present case, the initial orientation is defined in particular by the cylindrical-section-shaped recess 231 in the movable tray wall 227, the cylinder axis 253 of which is designed parallel to the axis of rotation 217 of the drum 205. In particular rotationally symmetrical bulk material parts are brought into this initial orientation by the above-described configuration, dimensioning and decrease in size of the conveyor trays 215, in particular of the receiving space 225.

The transfer of bulk material parts from the initial orientation, in which in particular the axis of symmetry of the bulk material parts is parallel to the axis of rotation 217 of the drum 205, into the target orientation is realized by rotating the axis of symmetry by 90°. In particular, the rotation is performed by 90° about an axis corresponding to a radial direction with respect to the axis of rotation 217 of the drum 205, with the result that the axis of symmetry of the bulk material part in the target orientation is oriented in the direction of the transfer station 211, in particular runs parallel to a tangent of the drum coat 219. In the two embodiments shown in FIGS. 1E and 2E, the orientation is realized by a movable orienting means 255. In both embodiments, a separate orienting means 255 is provided for each of the rows of conveyor trays 215 arranged around the axis of rotation 217, such that the bulk material parts in the individual rows of conveyor trays can be oriented independently of one another.

In the embodiment according to FIG. 1E, the movable orienting means 255 is a tilting gate 255 which can be moved into two positions and which, depending on the position, causes tilting of the bulk material part out of the initial orientation in different directions. For this purpose, the tilting gate 255 is pivotable about a pivot axis 257. Preferably, the tilting gate 255 is tilted back and forth between the two positions by means of a drive 259. In the illustrated position, the tilting gate 255 delimits an orienting channel 285 (cf. FIG. 1C) which is configured to taper towards the transfer station 211 in such a way that bulk material parts with a longitudinal axis, in particular under the influence of their weight force, are forced into the target orientation in which the longitudinal axis is oriented towards the transfer station 211. In the view of FIG. 1C, the tilting gate 255 is tilted to the left for this purpose. As a result, the orienting channel 285 tapers from left to right in the conveying direction F. As a result, for example a bulk material part in the form of a case, the axis of symmetry of which runs parallel to the axis of rotation 217 of the drum 205 in the initial orientation and the case base of which is oriented to the right, can be tilted in such a way that the case tilts with the case base first into the orienting channel 285. In cases in which the case base is oriented to the left in the initial orientation, the tilting gate 255 can be pivoted to the right, with the result that the orienting channel 285 tapers in such a way that the case also tilts with the case base first into the tapering orienting channel 285. As a result, an identical target orientation can be achieved for each bulk material part. In particular as a result of the possibility of individually controlling the movable orienting means 255 arranged next to one another in the axial direction A, bulk material parts oriented differently in the initial orientation can also be transferred simultaneously and independently of one another into the same target orientation.

In FIG. 1E, the singulating station transfers the singulated bulk material to the transfer station in a pre-acceleration section 256 which extends between an uppermost region, in the vertical direction, of the drum coat 219 and a region which is offset with respect to the uppermost region by 90° about the axis of rotation of the drum 205 in the conveying direction F. The pre-acceleration section 256 has a base which is formed by the drum coat 219, and two side walls 254 which are formed by arcuate ribs 254 which run above the drum coat 219 along the contour thereof. Thereby, the pre-acceleration section 256 and the chute track channel 287 form an S-shaped channel, at the vertex of which the orienting channel 285 is arranged.

FIG. 2E shows an alternative embodiment, in which the movable orienting means 255 is formed as a gripper. The gripper 255 is designed to grip each singulated bulk material part, transfer it from an initial orientation into a target orientation and then release it again, in particular release it to the transfer station 211. In a similar manner to that described above for the tilting gate 255, depending on the initial orientation (for example case base to the left or right), the gripper 255 can be designed to rotate the cases by 90° in different directions, for example to the left or to the right, in order to transfer them into the target orientation.

By means of the above-described configuration of the singulating station 203, a plurality of singulated bulk material parts which are transferred into an initial orientation can be fed simultaneously to the orienting station 209. Through the use of in each case one orienting means 255 for each singulated bulk material part which can be fed simultaneously to the orienting station, a simultaneous orientation of each bulk material part into the target orientation can be ensured.

In order to be able to ensure an identical orientation of each individual bulk material part even in the case of different initial orientations of the simultaneously fed bulk material parts, the sorting system furthermore has an orientation detection device 261 which is designed to detect the initial orientation of each singulated bulk material part individually. For this purpose, the orientation detection device 261 can have a plurality of cameras 263. The cameras 263 can be oriented towards the conveyor trays 215 which follow those conveyor trays 215 in the conveying direction F, the singulated bulk material parts of which are currently oriented by the orienting station 209. For this purpose, the orientation detection device 261, in particular the cameras 263 thereof, can be arranged above the orienting station 209, in particular in the direction of gravity. In particular, the cameras 263 can be fastened to a holding structure 265. The holding structure 265 can be a frame structure. In particular, the holding structure 265 can have a U-shaped structure, the limbs of which are fastened to the sorting system 201, in particular to the singulating device 203. The sorting system can furthermore have a controller which is designed to control the orienting station 209 differently in the case of different initial orientations which are detected by the orientation detection device 261.

Following the orienting station 209, the singulated and oriented bulk material parts are transferred to the transfer station 211. The transfer station 211 has a chute track 267, via which the singulated bulk material, under the influence of its weight force G and while maintaining its singulation, can be transferred to a further processing station (in FIG. 4 in the form of the illustrated workpiece carrier 100). The chute 267 has an acceleration section 269 which is inclined in the gravitational direction G and in which the bulk material part is accelerated under the influence of its weight force G. The chute 267 furthermore has an outlet section 271 which is inclined less strongly in the gravitational direction G with respect to the acceleration section 269, in particular is oriented substantially horizontally, and in which the bulk material is decelerated. The outlet section 271 adjoins the loading device 213 in the conveying direction F.

In the present case, the transfer station 211 has twelve chute tracks 267 which adjoin one another in the axial direction A (with respect to the axis of rotation 217) and converge in the direction of the loading device 213, in order to bring the singulated bulk material parts closer to one another while maintaining their singulation. Each of the chute tracks 267 has a chute track channel 287 (FIG. 1C) which is adapted to the dimension of the bulk material in such a way that the singulated bulk material part passes through the chute track 267 in a predetermined orientation, in particular the target orientation. For this purpose, the extension 289 of the chute track channels 287 in the axial direction A is designed to be smaller than the extension of the bulk material parts to be sorted along their axis of symmetry, with the result that tilting of the axis of symmetry in the chute track channel 287 by more than 90° is avoided. In particular, the chute track channel 287 for this purpose is delimited in the axial direction A by side walls 291 which project from a chute track base 293. As can be seen in particular from FIG. 1C, the chute track channel 287 adjoins the orienting channel 285 in the conveying direction F. From the beginning, as seen in the conveying direction F, of the chute track 267, the chute track channel 287 firstly tapers in the conveying direction and then remains constant in the acceleration section 269 over a certain range with regard to its width. In the transition region to the outlet section 271, the chute track channel 287 widens again. Once it has merged into the outlet section 271, the chute track channel 287 tapers again in the conveying direction F. At the downstream end in the conveying direction of the chute 267, in particular of the outlet section 271, the bulk material is transferred to the loading device 213.

The loading apparatus 213 has a pusher 273 and loading channels 275 which extend below the pusher 273. The pusher 273 is designed to be movable with respect to the loading channels 275. In particular, the pusher 273 is mounted in an axially displaceable manner via two bolts 277. The loading apparatus also has a drive 280 by means of which the pusher 273 can be displaced. As a result of a displacement of the pusher 273 in the conveying direction F, the singulated and oriented bulk material parts are pushed into the workpiece carrier 100. An exemplary embodiment of the inside of the loading device 213 is illustrated in FIGS. 5A to 5C. Therein, a bulk material part in the form of a case 3 passing through the loading device 213 is illustrated schematically. The loading channel base 281 is indicated by the reference number 281. A drop flap 279 is pivotably fastened to the pusher 273 via a pivot axis 283. As can be seen in the comparison of FIGS. 5A to 5C, by means of such an embodiment, the drop flap is first pivoted out of the loading channel counter to the direction of gravity G by the approaching bulk material part 3, with the result that the case 3 can pass through the loading channel 275 (FIG. 5B). After passing through (FIG. 5C), the drop flap 279 falls back into the loading channel 275 due to the gravitational force. The drop flap 279 has a contact edge 295 via which the bulk material part 3 is subsequently pushed into the workpiece carrier 100 by displacing the pusher 273 in the conveying direction F. Such a drop flap 279 is preferably provided for each chute track channel 287 or for each loading channel 275 adjoining it, such that all singulated bulk material parts 3 can be pushed simultaneously into the workpiece carrier 100.

The features disclosed in the above description, the figures and the claims can be significant both individually and in any desired combination for the realization of the invention in different configurations.

### LIST OF REFERENCE SIGNS

1 Laboratory system, system
3 bulk material part, case
5 Projectile
7 Ignition element
11 Case Insertion Station
13 Projectile insertion station
15 Propellant filling station
17 Case Forming Station
19 Projectile insertion station
21 Projectile assembly station
25 Ejection station
27 linear section
29 conveyor track
33 Interior space
43 Curved section
45 buffer zone
46 case mouth expansion station
47 Ignition element insertion station
48 Ignition element caulking station
49 Ignition element feed station
51 Pusher
53 Fluid application station
57 Case mouth sealing station
59 Quality monitoring station
69 Quality testing station
100 Workpiece carrier
101 ammunition
201 sorting system
203 Singulation apparatus, singulation station
205 endless conveyor, drum
207 Bulk material source
209 Orienting station
211 transfer station
213 Loading apparatus
215 Conveyor tray
217 axis of rotation
219 Drum shell
221 Axial extension
223′, 223″ circumferential position
225 Receiving space
227 Tray wall
229 planar surface
231 recess
233 pivot axis
235 tray base
237 bulk material supply[s]
239 conveyor belt
241 Bulk material supply space
243 chute
245 face-side wall
247 frame
249 ramp
251 width
255 Orienting means, tilting gate, gripper
256 Pre-acceleration section
257 pivot axis
259 drive
261 orientation detection device
263 camera
265 holding structure
267 chute track
269 acceleration section
271 outlet section
273 pusher
275 loading channel
277 bolts
279 drop flap
280 drive
281 loading channel base
283 pivot axis
285 Orienting channel
287 chute track channel
289 axial extension
291 side walls
293 chute track base
295 contact edge

1. Device for singulating bulk material, such as ammunition parts, for example cases and/or projectiles (5), comprising:
an endless conveyor (205) which is arranged with respect to a bulk material source (207) in such a way that bulk material falls under the influence of its weight force into conveyor trays (215), in particular being arranged in a row, of the endless conveyor (205) which are conveyed past the bulk material source (207);
characterized in that
the conveyor trays (215) have a receiving space (225) for the bulk material which decreases in size during the conveying.

2. Device according to claim 1, characterized in that the receiving space (225) decreases in size during the conveying from a bulk material receiving state, in which a multiplicity of, in particular identical, bulk material parts fit into the receiving space (225), into a singulating state, in which only a singulated bulk material part (3) fits into the receiving space (225),

3. Device according to claim 2, characterized in that the receiving space (225), in particular in the singulating state, is adapted to the shape of the bulk material in such a way that the bulk material is forced into a predefined initial orientation.

4. Device according to one of the preceding claims, characterized in that the receiving space (225) decreases in size in such a way that bulk material located in the receiving space (225) beyond a singulated bulk material part (3) falls out of the receiving space (225), in particular is pushed out of the latter.

5. Device according to one of the preceding claims, characterized in that the conveyor trays (215) each have a movable tray wall (227) for reducing the size of the respective receiving space (225).

6. Device according to claim 5, characterized in that the conveyor trays (215) each have a, in particular concavely shaped, tray base (235) with respect to which the respective tray wall can be moved.

7. Device, in particular according to one of the preceding claims, for singulating bulk material, such as ammunition parts, for example cases and/or projectiles (5), comprising:
an endless conveyor (205) which is arranged with respect to a bulk material source (207) in such a way that bulk material falls under the influence of its weight force into conveyor trays (215) of the endless conveyor (205) which are conveyed past the bulk material source (207),
characterized in that
the endless conveyor (205) comprises a drum (205), around the axis of rotation (217) of which the conveyor trays (215) are arranged in a row.

8. Device according to claim 7, characterized in that the conveyor shells (215) are formed by cutouts in the drum (205) preferably which starting from a drum coat (219) extend, in particular exclusively, inwards in the radial direction.

9. Device according to claim 7 or 8, characterized in that the endless conveyor (205) has at least two, preferably at least three, four, six, eight, ten or twelve, rows of conveyor trays (215) which are each arranged around the axis of rotation (217) of the drum (205).

10. Device according to one of the preceding claims 7 to 9, characterized in that the conveyor trays (215) are spaced apart from one another in the circumferential direction and/or in the axial direction by less than the greatest extent of the bulk material to be singulated, in particular wherein the rows of conveyor trays (215) according to claim 9 are spaced apart from one another in the axial direction by at most 50%, particularly preferably by at most 30% or 15%, of the greatest extent of the bulk material to be singulated.

11. Device according to one of claims 7 to 10, wherein the receiving space (225) is adapted to the shape of an axially symmetrical bulk material in such a way that the axis of symmetry of the bulk material is driven by its weight force into a parallel orientation with respect to the axis of rotation (217) of the drum (205).

12. Device according to one of the preceding claims, characterized by
a bulk material source (207) with a bulk material store which is open towards the endless conveyor (205) and preferably a conveying means, in particular conveyor belt (239), which moves the bulk material in the bulk material source (207) relative to the endless conveyor (205).

13. Sorting system (201) for the singulated feeding of oriented bulk material parts, in particular ammunition parts with at most one axis symmetry, comprising:
a singulating station (203, 205) for singulating bulk material, in particular a device according to one of claims 1 to 12;
an orienting station (209) for the identical orientation of each singulated bulk material part (3); and
a transfer station (211) via which the singulated and oriented bulk material part can be transferred to a further processing station.

14. Sorting system (201) according to claim 13, wherein the orienting station (209) is designed to transfer the singulated bulk material part (3) from an initial orientation in the singulating station (203, 205) into a target orientation.

15. Sorting system (201) according to claim 14, wherein the orienting station (209) is designed to transfer bulk material parts with an axis of symmetry, in particular an axis of rotational symmetry, into the target orientation by rotating the axis of symmetry, in particular by 10° to 270°, preferably by 30° to 180°, particularly preferably by 60° to 120°, for example by 90°.

16. Sorting system (201) according to one of claim 14 or 15, wherein the orienting station (209) has an orienting channel (285) which is designed to taper towards the transfer station (211) in such a way that bulk material parts with a longitudinal axis, in particular a longitudinal axis of symmetry, are forced into a target orientation, in particular under the influence of their weight force, in which the longitudinal axis is oriented towards the transfer station (211).

17. Sorting system (201) according to one of the preceding claims, wherein the orienting station (209) is designed to orient each singulated bulk material part (3) independently of the other singulated bulk material parts.

18. Sorting system (201) according to claim 17, wherein the orienting station (209) has at least one movable orienting means (255) for orienting.

19. Sorting system (201) according to claim 18, wherein the at least one movable orienting means is a tilting gate (255) which can be moved into two positions and which, depending on the position of the tilting gate, preferably causes tilting of the bulk material part out of the initial orientation in different directions, preferably wherein the tilting gate (255) limits the orienting channel (285) according to claim 16 in such a way that it tapers from different sides in the two positions of the tilting gate (255).

20. Sorting system (201) according to claim 18, wherein the at least one movable orienting means is a gripper (255) which is designed to grip each singulated bulk material part (3), transfer it from an initial orientation into a target orientation, in particular by rotation, and then release it again, in particular transfer it to the transfer station (211).

21. Sorting system (201) according to one of claims 13 to 20, wherein the singulating station (203, 205) is designed to singulate bulk material with an axis of symmetry, in particular an axis of rotational symmetry, such as cases and/or projectiles (5), by transferring the axis of symmetry of each bulk material part into a predetermined initial orientation, wherein the singulating station (203, 205) for this purpose is preferably designed as described in claim 11.

22. Sorting system (201) according to one of claims 13 to 21, further comprising
an orientation detection device (261) which is designed to detect an initial orientation of the singulated bulk material part (3) in the singulating station (203, 205), in particular is designed to detect the position of the sides along the axis of symmetry in the case of bulk material with sides which can be distinguished from one another along an axis of symmetry, in particular an axis of rotational symmetry.

23. Sorting system (201) according to one of claims 13 to 22, further comprising
a controller which is designed to control the orienting station (209) differently in the case of different initial orientations of the bulk material parts.

24. Sorting system (201) according to one of claims 13 to 23, wherein the singulating station (203, 205) is designed to feed at least two, preferably at least three, four, six, eight, ten or twelve, singulated bulk material parts simultaneously to the orienting station, preferably is designed according to one of claims 7 to 11.

25. Sorting system (201) according to claim 24, wherein the orienting station (209) is designed to orient the at least two, preferably at least three, four, six, eight, ten or twelve, singulated bulk material parts simultaneously and independently of one another, wherein the orienting station (209) for this purpose preferably has at least two, in particular at least three, four, six, eight, ten or twelve, movable orienting means which are preferably designed as described in claim 18 or 20.

26. Sorting system (201), in particular according to one of claims 13 to 25, for the singulated feeding of oriented bulk material parts, in particular ammunition parts with at most one axis symmetry, comprising:
a singulating station (203, 205) for singulating bulk material, in particular a device according to one of claims 1 to 12; and
a transfer station (211) with at least one chute track (267) via which the singulated bulk material part (3) can be transferred to a further processing station under the influence of its weight force and while maintaining its singulation.

27. Sorting system (201) according to claim 26, wherein the at least one chute track (267) is adapted to the dimension of the bulk material in such a way that the singulated bulk material part (3) passes the chute track (267) in a predetermined orientation.

28. Sorting system (201) according to claim 26 or 27, wherein the at least one chute track (267) has an acceleration section (269) which is inclined in the direction of gravity and in which the bulk material part is accelerated under the influence of its weight force, and an outlet section (271) which is inclined to a lesser extent in the direction of gravity, in particular being oriented substantially horizontally, with respect to the acceleration section (269) and in which the bulk material part is decelerated.

29. Sorting system (201) according to one of claims 26 to 28, wherein the transfer station (211) has a loading device (213) which receives the singulated bulk material part (3) from the chute track (267) and is designed to transfer it into the further processing station, in particular in the form of a workpiece carrier (100) which is movably guided past the sorting system (201).

30. Sorting system (201) according to claim 29, wherein the loading device (213) has a pusher (273) which is designed to push the singulated bulk material part (3) into receptacles, in particular adapted thereto, of the further processing station.

31. Sorting system (201) according to one of claims 26 to 30, wherein the singulating station (203, 205) is designed to feed at least two, preferably at least three, four, six, eight, ten or twelve, singulated bulk material parts simultaneously to the transfer station (211), preferably is designed according to one of claims 8 to 12.

32. Sorting system (201) according to claim 31, comprising at least two, preferably at least three, four, six, eight, ten or twelve, chute tracks (267) via which the singulated bulk material parts (3) can be transferred to a further processing station simultaneously under the influence of their weight force and while maintaining their singulation.

33. Sorting system (201) according to claim 32, wherein the chute tracks (267) converge towards one another in the direction of the further processing station in order to bring the singulated bulk material parts (3) closer to one another while maintaining their singulation.

34. Sorting system (201) according to claim 32 or 33, wherein the transfer station (211) has a loading device (213) which receives the singulated bulk material parts (3) from the chute tracks (267) and is designed to transfer them simultaneously to the further processing station, in particular in the form of a workpiece carrier (100) which is movably guided past the sorting system (201).

35. System for the production of ammunition, which has a case, an ignition element and a projectile (5), comprising
at least one sorting system (201) according to one of claims 13 to 34 and/or a device according to one of claims 1 to 12, for singulating at least one ammunition part, in particular the case and/or the projectile (5).

36. System according to claim 35, comprising
at least two sorting systems according to one of claims 13 to 34 and/or in each case a device according to one of claims 1 to 12, in order to singulate a case or a projectile (5), in particular a case, with one sorting system (201), and to singulate a further ammunition part, in particular a projectile (5), with the other sorting system.

37. System according to claim 35 or 36, further comprising:
an ignition element insertion station (47) for inserting an ignition element into the case;
a propellant filling station (15) for filling the case with propellant powder;
a projectile mounting station (19, 21) for placing the projectile (5) onto the case; and
a circulating conveying system for transporting in each case a plurality of the ammunition parts, in particular a plurality of cases and/or projectiles (5), to, from and/or between a plurality of production stations.

38. System according to claim 37, wherein the circulating conveying system has at least one, preferably a multiplicity of, workpiece carriers (100) which is conveyed past the at least one sorting system (201) in such a way that it is loaded with the singulated ammunition parts via the transfer station (211).

39. Use of a device according to one of claims 1 to 12 for singulating ammunition parts or of a sorting system (201) according to one of claims 13 to 34 for singulated feeding of ammunition parts, in particular to a workpiece carrier (100).
